(19) United States
(12) Patent Application Publication
(10) Pub. No.: US 2021/0127144 A1
(43) Pub. Date: Apr. 29, 2021

(54) SYSTEMS AND METHODS FOR SIGNALING INFORMATION FOR VIRTUAL REALITY APPLICATIONS

(71) Applicant: SHARP KABUSHIKI KAISHA, Sakai City, Osaka (JP)

(72) Inventor: SACHIN G. DESHPANDE, Vancouver, WA (US)

(21) Appl. No.: 16/497,207

(22) PCT Filed: Feb. 5, 2018
(86) PCT No.: PCT/JP2018/003854

§ 371 Date: Sep. 24, 2019

Related U.S. Application Data
(60) Provisional application No. 62/482,121, filed on Apr. 5, 2017.
(60) Provisional application No. 62/476,849, filed on Mar. 26, 2017.

(51) Int. Cl. H04N 21/235; H04N 21/81; H04N 21/2343

(52) U.S. Cl. CPC H04N 21/235; H04N 21/2343; H04N 21/816

(57) ABSTRACT

A device may be configured to signal information (for example, Media Presentation Description (MPD)) for virtual reality applications (for example, omnidirectional video) according to one or more of the techniques described herein.

### CROSS REFERENCE

This Nonprovisional application claims priority under 35 U.S.C. § 119 on provisional Application No. 62/476,849 on Mar. 26, 2017 and Application No. 62/482,121 on Apr. 5, 2017, the entire contents of which are hereby incorporated by reference.

### TECHNICAL FIELD

This disclosure relates to the field of interactive video distribution and more particularly to techniques for signaling of information associated with virtual reality applications.

### BACKGROUND ART

Digital media playback capabilities may be incorporated into a wide range of devices, including digital televisions, including so-called “smart” televisions, set-top boxes, laptop or desktop computers, tablet computers, digital recording devices, digital media players, video gaming devices, cellular phones, including so-called “smart” phones, dedicated video streaming devices, and the like. Digital media content (e.g., video and audio programming) may originate from a plurality of sources including, for example, over-the-air television providers, satellite television providers, cable television providers, online media service providers, including, so-called streaming service providers, and the like. Digital media content may be delivered over packet-switched networks, including bidirectional networks, such as Internet Protocol (IP) networks and unidirectional networks, such as digital broadcast networks.

Digital video included in digital media content may be coded according to a video coding standard. Video coding standards may incorporate video compression techniques. Examples of video coding standards include ISO/JEC MPEG-4 Visual and ITU-T H.264 (also known as ISO/JEC MPEG-4 AVC) and High-Efficiency Video Coding (HEVC). Video compression techniques enable data requirements for storing and transmitting video data to be reduced. Video compression techniques may reduce data requirements by exploiting the inherent redundancies in a video sequence. Video compression techniques may sub-divide a video sequence into successively smaller portions (i.e., groups of frames within a video sequence, a frame within a group of frames, slices within a frame, coding tree units (e.g., macroblocks) within a slice, coding blocks within a coding tree unit, etc.). Prediction coding techniques may be used to generate difference values between a unit of video data to be coded and a reference unit of video data. The difference values may be referred to as residual data. Residual data may be coded as quantized transform coefficients. Syntax elements may relate residual data and a reference coding unit. Residual data and syntax elements may be included in a compliant bitstream. Compliant bitstreams and associated metadata may be formatted according to data structures. Compliant bitstreams and associated metadata may be transmitted from a source to a receiver device (e.g., a digital television or a smart phone) according to a transmission standard. Examples of transmission standards include Digital Video Broadcasting (DVB) standards, Integrated Services Digital Broadcasting Standards (ISDB) standards, and standards developed by the Advanced Television Systems Committee (ATSC), including, for example, the ATSC 2.0 standard. The ATSC is currently developing the so-called ATSC 3.0 suite of standards.

### SUMMARY OF INVENTION

One embodiment of the present invention discloses a method of signaling information associated with an omnidirectional video, the method comprising: signaling information associated with an omnidirectional video using a media presentation description document.

One embodiment of the present invention discloses a method of determining information associated with an omnidirectional video, the method comprising: parsing information associated with an omnidirectional video from a media presentation description document.

### BRIEF DESCRIPTION OF DRAWINGS

FIG. 1 is a block diagram illustrating an example of a system that may be configured to transmit coded video data according to one or more techniques of this disclosure.

FIG. 2A is a conceptual diagram illustrating coded video data and corresponding data structures according to one or more techniques of this disclosure.

FIG. 2B is a conceptual diagram illustrating coded video data and corresponding data structures according to one or more techniques of this disclosure.

FIG. 3 is a conceptual diagram illustrating coded video data and corresponding data structures according to one or more techniques of this disclosure.

FIG. 4 is a conceptual drawing illustrating an example of components that may be included in an implementation of a system that may be configured to transmit coded video data according to one or more techniques of this disclosure.

FIG. 5 is a block diagram illustrating an example of a data encapsulator that may implement one or more techniques of this disclosure.

FIG. 6 is a block diagram illustrating an example of a receiver device that may implement one or more techniques of this disclosure.

FIG. 7 is a computer program listing illustrating an example of signaling metadata according to one or more techniques of this disclosure.

FIG. 8 is a computer program listing illustrating an example of signaling metadata according to one or more techniques of this disclosure.

FIG. 9 is a computer program listing illustrating an example of signaling metadata according to one or more techniques of this disclosure.

FIG. 10 is a computer program listing illustrating an example of signaling metadata according to one or more techniques of this disclosure.

FIG. 11 is a computer program listing illustrating an example of signaling metadata according to one or more techniques of this disclosure.

### DESCRIPTION OF EMBODIMENTS

In general, this disclosure describes various techniques for signaling information associated with a virtual reality application. In particular, this disclosure describes techniques for signaling information associated with omnidirectional video. It should be noted that although in some examples the techniques of this disclosure are described with respect to transmission standards, the techniques described herein may be generally applicable. For example, the techniques described herein are generally applicable to any of DVB standards, ISDB standards, ATSC Standards, Digital Terrestrial Multimedia Broadcast (DTMB) standards, Digital Multimedia Broadcast (DMB) standards, Hybrid Broadcast and Broadband Television (HbbTV) standards, World Wide Web Consortium (W3C) standards, and Universal Plug and Play (UPnP) standard. Further, it should be noted that although techniques of this disclosure are described with respect to ITU-T H.264 and ITU-T H.265, the techniques of this disclosure are generally applicable to video coding, including omnidirectional video coding. For example, the coding techniques described herein may be incorporated into video coding systems, (including video coding systems based on future video coding standards) including block structures, intra prediction techniques, inter prediction techniques, transform techniques, filtering techniques, and/or entropy coding techniques other than those included in ITU-T H.265. Thus, reference to ITU-T H.264 and ITU-T H.265 is for descriptive purposes and should not be construed to limit the scope of the techniques described herein. Further, it should be noted that incorporation by reference of documents herein should not be construed to limit or create ambiguity with respect to terms used herein. For example, in the case where an incorporated reference provides a different definition of a term than another incorporated reference and/or as the term is used herein, the term should be interpreted in a manner that broadly includes each respective definition and/or in a manner that includes each of the particular definitions in the alternative.

In one example, a method of signaling information associated with an omnidirectional video comprises signaling information associated with an omnidirectional video using a media presentation description document.

In one example, a device comprises one or more processors configured to signal information associated with an omnidirectional video using a media presentation description document.

In one example, a non-transitory computer-readable storage medium comprises instructions stored thereon that, when executed, cause one or more processors of a device to signal information associated with an omnidirectional video using a media presentation description document.

In one example, an apparatus comprises means for signaling information associated with an omnidirectional video using a media presentation description document.

In one example, a method of determining information associated with an omnidirectional video comprises parsing information associated with an omnidirectional video from a media presentation description document.

In one example, a device comprises one or more processors configured to parse information associated with an omnidirectional video from a media presentation description document.

In one example, a non-transitory computer-readable storage medium comprises instructions stored thereon that, when executed, cause one or more processors of a device to parse information associated with an omnidirectional video from a media presentation description document.

In one example, an apparatus comprises means for parsing information associated with an omnidirectional video from a media presentation description document.

The details of one or more examples are set forth in the accompanying drawings and the description below. Other features, objects, and advantages will be apparent from the description and drawings, and from the claims.

Video content typically includes video sequences comprised of a series of frames. A series of frames may also be referred to as a group of pictures (GOP). Each video frame or picture may include a one or more slices, where a slice includes a plurality of video blocks. A video block may be defined as the largest array of pixel values (also referred to as samples) that may be predictively coded. Video blocks may be ordered according to a scan pattern (e.g., a raster scan). A video encoder performs predictive encoding on video blocks and sub-divisions thereof. ITU-T H.264 specifies a macroblock including 16×16 luma samples. ITU-T H.265 specifies an analogous Coding Tree Unit (CTU) structure where a picture may be split into CTUs of equal size and each CTU may include Coding Tree Blocks (CTB) having 16×16, 32×32, or 64×64 luma samples. As used herein, the term video block may generally refer to an area of a picture or may more specifically refer to the largest array of pixel values that may be predictively coded, sub-divisions thereof, and/or corresponding structures. Further, according to ITU-T H.265, each video frame or picture may be partitioned to include one or more tiles, where a tile is a sequence of coding tree units corresponding to a rectangular area of a picture.

In ITU-T H.265, the CTBs of a CTU may be partitioned into Coding Blocks (CB) according to a corresponding quadtree block structure. According to ITU-T H.265, one luma CB together with two corresponding chroma CBs and associated syntax elements are referred to as a coding unit (CU). A CU is associated with a prediction unit (PU) structure defining one or more prediction units (PU) for the CU, where a PU is associated with corresponding reference samples. That is, in ITU-T H.265 the decision to code a picture area using intra prediction or inter prediction is made at the CU level and for a CU one or more predictions corresponding to intra prediction or inter prediction may be used to generate reference samples for CBs of the CU. In ITU-T H.265, a PU may include luma and chroma prediction blocks (PBs), where square PBs are supported for intra prediction and rectangular PBs are supported for inter prediction. Intra prediction data (e.g., intra prediction mode syntax elements) or inter prediction data (e.g., motion data syntax elements) may associate PUs with corresponding reference samples. Residual data may include respective arrays of difference values corresponding to each component of video data (e.g., luma (Y) and chroma (Cb and Cr)). Residual data may be in the pixel domain. A transform, such as, a discrete cosine transform (DCT), a discrete sine transform (DST), an integer transform, a wavelet transform, or a conceptually similar transform, may be applied to pixel difference values to generate transform coefficients. It should be noted that in ITU-T H.265, CUs may be further sub-divided into Transform Units (TUs). That is, an array of pixel difference values may be sub-divided for purposes of generating transform coefficients (e.g., four 8×8 transforms may be applied to a 16×16 array of residual values corresponding to a 16×16 luma CB), such sub-divisions may be referred to as Transform Blocks (TBs). Transform coefficients may be quantized according to a quantization parameter (QP). Quantized transform coefficients (which may be referred to as level values) may be entropy coded according to an entropy encoding technique (e.g., content adaptive variable length coding (CAVLC), context adaptive binary arithmetic coding (CABAC), probability interval partitioning entropy coding (PIPE), etc.). Further, syntax elements, such as, a syntax element indicating a prediction mode, may also be entropy coded. Entropy encoded quantized transform coefficients and corresponding entropy encoded syntax elements may form a compliant bitstream that can be used to reproduce video data. A binarization process may be performed on syntax elements as part of an entropy coding process. Binarization refers to the process of converting a syntax value into a series of one or more bits. These bits may be referred to as “bins.”

Virtual Reality (VR) applications may include video content that may be rendered with a head-mounted display, where only the area of the spherical video that corresponds to the orientation of the user's head is rendered. VR applications may be enabled by omnidirectional video, which is also referred to as 360 degree spherical video of 360 degree video. Omnidirectional video is typically captured by multiple cameras that cover up to 360 degrees of a scene. A distinct feature of omnidirectional video compared to normal video is that, typically only a subset of the entire captured video region is displayed, i.e., the area corresponding to the current user's field of view (FOV) is displayed. A FOV is sometimes also referred to as viewport. In other cases, a viewport may be part of the spherical video that is currently displayed and viewed by the user. It should be noted that the size of the viewport can be smaller than or equal to the field of view. Further, it should be noted that omnidirectional video may be captured using monoscopic or stereoscopic cameras. Monoscopic cameras may include cameras that capture a single view of an object. Stereoscopic cameras may include cameras that capture multiple views of the same object (e.g., views are captured using two lenses at slightly different angles). Further, it should be noted that in some cases, images for use in omnidirectional video applications may be captured using ultra wide-angle lens (i.e., so-called fisheye lens). In any case, the process for creating 360 degree spherical video may be generally described as stitching together input images and projecting the stitched together input images onto a three-dimensional structure (e.g., a sphere or cube), which may result in so-called projected frames. Further, in some cases, regions of projected frames may be transformed, resized, and relocated, which may result in a so-called packed frame.

A most-interested region in an omnidirectional video picture may refer to a subset of the entire video region that is statistically the most likely to be rendered to the user at the presentation time of that picture (i.e., most likely to be in a FOV). It should be noted that most-interested regions of an omnidirectional video may be determined by the intent of a director or producer, or derived from user statistics by a service or content provider (e.g., through the statistics of which regions have been requested/seen by the most users when the omnidirectional video content was provided through a streaming service). Most-interested regions may be used for data pre-fetching in omnidirectional video adaptive streaming by edge servers or clients, and/or transcoding optimization when an omnidirectional video is transcoded, e.g., to a different codec or projection mapping. Thus, signaling most-interested regions in an omnidirectional video picture may improve system performance by lowering transmission bandwidth and lowering decoding complexity. It should be noted that most-interested region may instead be referred to as most-interesting region or as region-of-interest.

Transmission systems may be configured to transmit omnidirectional video to one or more computing devices. Computing devices and/or transmission systems may be based on models including one or more abstraction layers, where data at each abstraction layer is represented according to particular structures, e.g., packet structures, modulation schemes, etc. An example of a model including defined abstraction layers is the so-called Open Systems Interconnection (OSI) model. The OSI model defines a 7-layer stack model, including an application layer, a presentation layer, a session layer, a transport layer, a network layer, a data link layer, and a physical layer. It should be noted that the use of the terms upper and lower with respect to describing the layers in a stack model may be based on the application layer being the uppermost layer and the physical layer being the lowermost layer. Further, in some cases, the term “Layer 1” or “L1” may be used to refer to a physical layer, the term “Layer 2” or “L2” may be used to refer to a link layer, and the term “Layer 3” or “L3” or “IP layer” may be used to refer to the network layer.

A physical layer may generally refer to a layer at which electrical signals form digital data. For example, a physical layer may refer to a layer that defines how modulated radio frequency (RF) symbols form a frame of digital data. A data link layer, which may also be referred to as a link layer, may refer to an abstraction used prior to physical layer processing at a sending side and after physical layer reception at a receiving side. As used herein, a link layer may refer to an abstraction used to transport data from a network layer to a physical layer at a sending side and used to transport data from a physical layer to a network layer at a receiving side. It should be noted that a sending side and a receiving side are logical roles and a single device may operate as both a sending side in one instance and as a receiving side in another instance. A link layer may abstract various types of data (e.g., video, audio, or application files) encapsulated in particular packet types (e.g., Motion Picture Expert Group—Transport Stream (MPEG-TS) packets, Internet Protocol Version 4 (IPv4) packets, etc.) into a single generic format for processing by a physical layer. A network layer may generally refer to a layer at which logical addressing occurs. That is, a network layer may generally provide addressing information (e.g., Internet Protocol (IP) addresses) such that data packets can be delivered to a particular node (e.g., a computing device) within a network. As used herein, the term network layer may refer to a layer above a link layer and/or a layer having data in a structure such that it may be received for link layer processing. Each of a transport layer, a session layer, a presentation layer, and an application layer may define how data is delivered for use by a user application.

Choi et al., ISO/IEC JTC1/SC29/WG11 N16636, “MPEG-A Part 20 (WD on ISO/IEC 23000-20): Omnidirectional Media Application Format,” January 2017, Geneva, CH, which is incorporated by reference and herein referred to as Choi, defines a media application format that enables omnidirectional media applications. Choi specifies a list of projection techniques that can be used for conversion of a spherical or 360 degree video into a two-dimensional rectangular video; how to store omnidirectional media and the associated metadata using the International Organization for Standardization (ISO) base media file format (ISOBMFF); how to encapsulate, signal, and stream omnidirectional media using dynamic adaptive streaming over Hypertext Transfer Protocol (HTTP) (DASH); and which video and audio coding standards, as well as media coding configurations, may be used for compression and playback of the omnidirectional media signal.

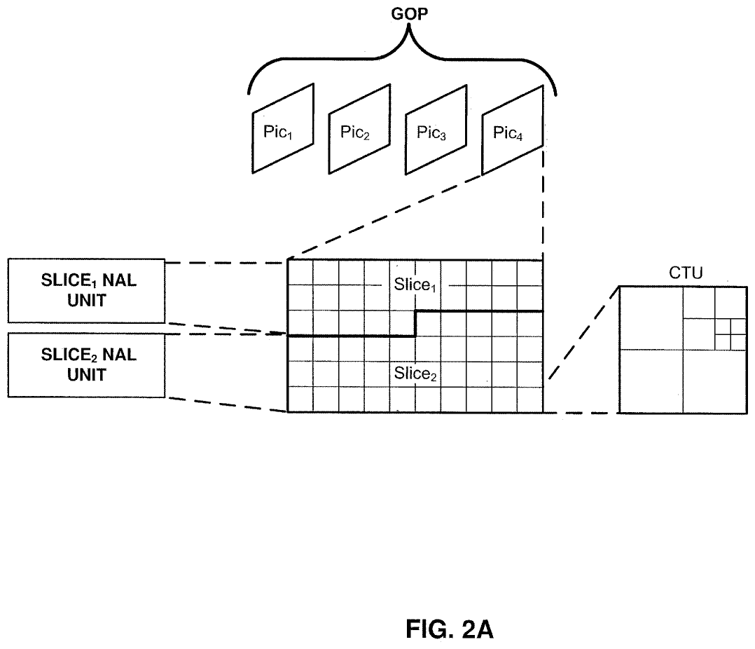

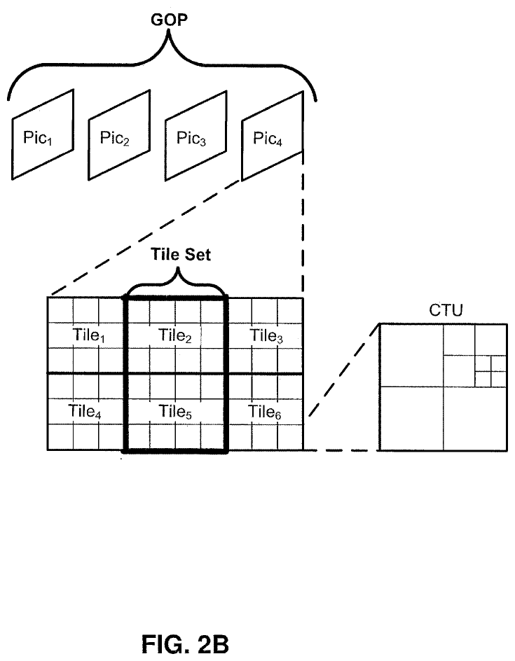

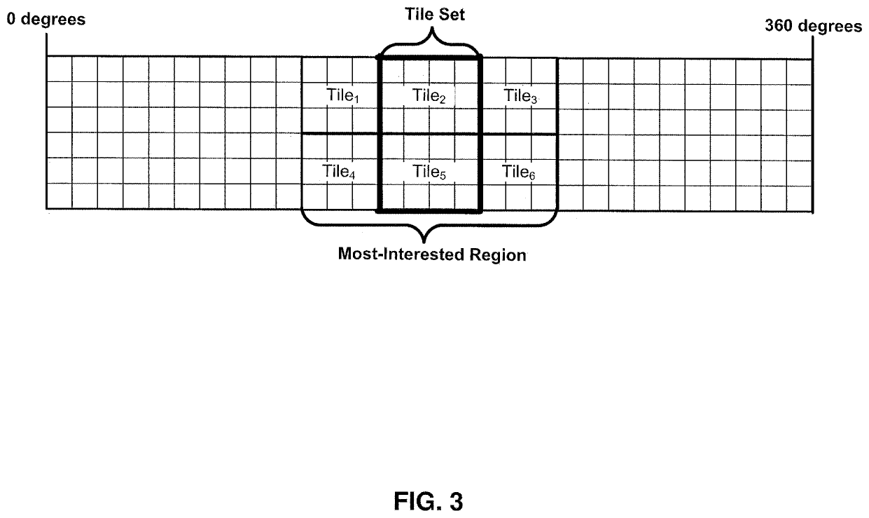

Choi provides where video is coded according to ITU-T H.265. ITU-T H.265 is described in High Efficiency Video Coding (HEVC), Rec. ITU-T H.265 April 2015, which is incorporated by reference, and referred to herein as ITU-T H.265. As described above, according to ITU-T H.265, each video frame or picture may be partitioned to include one or more slices and further partitioned to include one or more tiles. FIGS. 2A-3 are conceptual diagrams illustrating an example of a group of pictures including slices and further partitioning pictures into tiles. In the example illustrated in FIG. 2A, Pic₄ is illustrated as including two slices (i.e., Slice₁ and Slice₂) where each slice includes a sequence of CTUs (e.g., in raster scan order). In the example illustrated in FIG. 2B, Pic₄ is illustrated as including six tiles (i.e., Tile₁ to Tile₆), where each tile is rectangular and includes a sequence of CTUs. It should be noted that in ITU-T H.265, a tile may consist of coding tree units contained in more than one slice and a slice may consist of coding tree units contained in more than one tile. However, ITU-T H.265 provides that one or both of the following conditions shall be fulfilled: (1) All coding tree units in a slice belong to the same tile; and (2) All coding tree units in a tile belong to the same slice. Thus, with respect to FIG. 2B, each of the tiles may belong to a respective slice (e.g., Tile₁ to Tile₆ may respectively belong to slices, Slice₁ to Slice₆) or multiple tiles may belong to a slice (e.g., Tile₁ to Tile₃ may belong to Slice₁ and Tile₄ to Tile₆ may belong to Slice₂).

Further, as illustrated in FIG. 2B, tiles may form tile sets (i.e., Tile₂ and Tile₅ form a tile set). Tile sets may be used to define boundaries for coding dependencies (e.g., intra-prediction dependencies, entropy encoding dependencies, etc.,) and as such, may enable parallelism in coding and region-of-interest coding. For example, if the video sequence in the example illustrated in FIG. 2B corresponds to a nightly news program, the tile set formed by Tile₂ and Tile₅ may correspond to a visual region-of-interest including a news anchor reading the news. As illustrated in FIG. 3, Tile₁ to Tile₆ may form a most-interested region of an omnidirectional video. Viewport dependent video coding, which may also be referred to as viewport dependent partial video coding, may be used to enable coding of only part of an entire video region. That is, for example, viewport dependent video coding may be used to provide sufficient information for rendering of a current FOV. For example, omnidirectional video may be coded such that each potential region covering a viewport can be independently coded from other regions across time. In this case, for example, for a particular current viewport, a minimum set of tiles that cover a viewport may be sent to the client, decoded, and/or rendered. This process may be referred to as simple tile based partial decoding (STPD).

As described above, Choi specifies a list of projection techniques that can be used for conversion of a spherical or 360 degree video into a two-dimensional rectangular video. Choi specifies where a projected frame is a frame that has a representation format by a 360 degree video projection indicator and where a projection is the process by which a set of input images are projected onto a projected frame. Further, Choi specifies where a projection structure includes a three-dimensional structure including one or more surfaces on which the captured image/video content is projected, and from which a respective projected frame can be formed. Finally, Choi provides where a region-wise packing includes a region-wise transformation, resizing, and relocating of a projected frame and where a packed frame is a frame that results from region-wise packing of a projected frame. Thus, in Choi, the process for creating 360 degree spherical video may be described as including image stitching, projection, and region-wise packing. It should be noted that Choi specifies a coordinate system, omnidirectional projection formats, including an equirectangular projection, a rectangular region-wise packing format, and an omnidirectional fisheye video format, for the sake of brevity, a complete description of these sections of Choi is not provided herein. However, reference is made to the relevant sections of Choi.

It should be noted that in Choi, if region-wise packing is not applied, the packed frame is identical to the projected frame. Otherwise, regions of the projected frame are mapped onto a packed frame by indicating the location, shape, and size of each region in the packed frame. Further, in Choi, in the case of stereoscopic 360 degree video, the input images of one time instance are stitched to generate a projected frame representing two views, one for each eye. Both views can be mapped onto the same packed frame and encoded by a traditional two-dimensional video encoder. Alternatively, Choi provides, where each view of the projected frame can be mapped to its own packed frame, in which case the image stitching, projection, and region-wise packing is similar to the monoscopic case described above. Further, in Choi, a sequence of packed frames of either the left view or the right view can be independently coded or, when using a multiview video encoder, predicted from the other view. Finally, it should be noted that in Choi, the image stitching, projection, and region-wise packing process can be carried out multiple times for the same source images to create different versions of the same content, e.g. for different orientations of the projection structure and similarly, the region-wise packing process can be performed multiple times from the same projected frame to create more than one sequence of packed frames to be encoded.

As described above, Choi specifies how to store omnidirectional media and the associated metadata using the International Organization for Standardization (ISO) base media file format (ISOBMFF). Choi specifies where a file format that generally supports the following types of metadata: (1) metadata specifying the projection format of the projected frame; (2) metadata specifying the area of the spherical surface covered by the projected frame; (3) metadata specifying the orientation of the projection structure corresponding to the projected frame in a global coordinate system; (4) metadata specifying region-wise packing information; and (5) metadata specifying optional region-wise quality ranking.

Further, Choi specifies where the file format supports the following types of boxes: a scheme type box (SchemeTypeBox), a scheme information box (SchemelnformationBox), a projected omnidirectional video box (ProjectedOmnidirectionalVideoBox), a stereo video box (StereoVideoBox), a fisheye omnidirectional video box (FisheyeOmnidirectionalVideoBox), and a region-wise packing box (RegionWisePackingBox). It should be noted that Choi specifies additional types boxes, for the sake of brevity, a complete description of all the type of boxes specified in Choi are not described herein. With respect to SchemeTypeBox, SchemeInformationBox, ProjectedOmnidirectionalVideoBox, StereoVideoBox, and RegionWisePackingBox, Choi provides the following:
The use of the omnidirectional video scheme for the restricted video sample entry type ‘resv’ indicates that the decoded pictures are either fisheye video pictures or packed frames containing either monoscopic or stereoscopic content. The use of the omnidirectional video scheme is indicated by scheme_type equal to ‘odvd’ (omnidirectional video) within the SchemeTypeBox.
The format of the projected monoscopic frames is indicated with the ProjectedOmnidirectionalVideoBox contained within the SchemenformationBox. The format of fisheye video is indicated with the FisheyeOmnidirectionalVideoBox contained within the SchemeInformationBox. One and only one of ProjectedOmnidirectionalVideoBox and FisheyeOnmidirectionalVideoBox shall be present in the SchemeInformationBox when the scheme type is ‘odvd’.
When the ProjectedOmnidirectionalVideoBox is present in the SchemelnformationBox, StereoVideoBox and RegionWisePackingBox may be present in the same SchemeInformationBox. When FisheyeOmnidirectionalVideoBox is present in the SchemeInformationBox, StereoVideoBox and RegionWisePackingBox shall not be present in the same SchemenformationBox.
For stereoscopic video, the frame packing arrangement of the projected left and right frames is indicated with the StereoVideoBox contained within the SchemeInformationBox. The absence of StereoVideoBox indicates that the omnidirectionally projected content of the track is monoscopic. When StereoVideoBox is present in the SchemelnformationBox for the omnidirectional video scheme, it shall indicate either top-bottom frame packing or side-to-side frame packing.
Optional region-wise packing is indicated with the RegionWisePackingBox contained within the SchemeInformationBox. The absence of RegionWisePackingBox indicates that no region-wise packing is applied.

With respect to the projected omnidirectional video box, Choi provides the following definition, syntax and semantics:

### Definition

Box Type: ‘povd’
Container: Scheme Information box (‘schi’)
Mandatory: No
Quantity: Zero or one (when scheme_type is equal to ‘odvd’, either ‘povd’ or ‘fovd’ must be present)
ProjectedOmnidirectionalVideoBox is used to indicate that samples contained in the track are projected or packed frames.
The properties of the projected frames are indicated with the following:
   the projection format of a monoscopic projected frame (C for monoscopic video contained in the track, CL and CR for left and right view of stereoscopic video);
   the orientation of the projection structure relative to the global coordinate system; and
   the spherical coverage of the projected omnidirectional video (i.e., the area on the spherical surface that is represented by the projected frame).

### Syntax

aligned(8) class ProjectedOmnidirectionalVideoBox extends Box(‘povd’)
{

ProjectionFormatBox( ); // mandatory
ProjectionOrientationBox( ); // optional
CoverageInformationBox( ); // optional

}
aligned(8) class ProjectionFormatBox( ) extends FullBox(‘prfr’, 0, 0) {

ProjectionFormatStruct( );

}
aligned(8) class ProjectionFormatStruct( ) {

bit(1) reserved = 0;
unsigned int(6) geometry_type;
bit(1) reserved = 0;
unsigned int(8) projection_type;

}

### Semantics

geometry_type indicates the mathematical convention where points within a space can be uniquely identified by a location in one or more dimensions. When geometry_type is equal to 1, the projection indicator is given in spherical coordinates, where ϕ is the azimuth (longitude) or the YawAngle and θ is the elevation (latitude) or the PitchAngle, according to the specified coordinate system. Other values of geometry_type are reserved.
projection_type indicates the particular mapping of the rectangular decoder picture output samples onto the coordinate system specified by geometry_type. When projection-type is equal to 1, geometry_type shall be equal to 1. projection_type equal to 1 indicates the a specified equirectangular projection. Other values of projection_type are reserved.

With respect to the Fisheye omnidirectional video box, Choi provides the following definition and syntax:

### Definition

Box Type: ‘fovd’
Container: Scheme Information box (‘schi’)
Mandatory: No
Quantity: Zero or one (when scheme_type is equal to ‘odvd’, either ‘povd’ or ‘fovd’ must be present)
FisheyeOmnidirectionalVideoBox is used to indicate that samples contained in the track contain multiple circular images captured by fisheye cameras.

### Syntax

aligned(8) class FisheyeOmnidirectionalVideoBox extends FullBox(‘fovd’,
0, 0) {

FisheyeOmnidirectionalVideoInfo( ); //Described in Section 6.2 of
Choi

}

With respect to the Region-wise packing box, Choi provides the following definition, syntax, and semantics:

### Definition

Box Type: ‘rwpk’
Container: Scheme Information box (‘schi’)
Mandatory: No
Quantity: Zero or one
RegionWisePackingBox indicates that projected frames are packed region-wise and require unpacking prior to rendering.

### Syntax

aligned(8) class RegionWisePackingBox extends Box(‘rwpk’) {

RegionWisePackingStruct( );

}
aligned(8) class RegionWisePackingStruct {

unsigned int(8) num_regions;
unsigned int(32) proj_frame_width;
unsigned int(32) proj_frame_height;
for (i = 0; i < num_regions; i++) {

bit(4) reserved = 0;
unsigned int(4) packing_type[i];

}
for (i = 0; i < num_regions; i++) {

if (packing_type[i] == 0)

RectRegionPacking(i);

}

}

### Semantics

num_regions specifies the number of packed regions. Value 0 is reserved.
proj_frame_width and proj_frame_height specify the width and height, respectively, of the projected frame.
packing_type specifies the type of region-wise packing. packing type equal to 0 indicates rectangular region-wise packing. Other values are reserved.

It should be noted that with respect to a StereoVideoBox, ISO/JEC 14496-12:2015 “Information technology—Coding of audio-visual objects—Part 12: ISO Base Media File Format, which is incorporated by reference, provides the following definition, syntax, and semantics:

### Definition

Box Type: ‘stvi’
Container: Scheme Information box (‘schi’)
Mandatory: Yes (when SchemeType is ‘stvi’)
Quantity: One
The Stereo Video box is used to indicate that decoded frames either contain a representation of two spatially packed constituent frames that form a stereo pair or contain one of two views of a stereo pair. The Stereo Video box shall be present when the SchemeType is ‘stvi’.

### Syntax

aligned(8) class StereoVideoBox extends extends FullBox(‘stvi’, version =
0, 0)
{
template unsigned int(30) reserved = 0;
unsigned int(2) single_view_allowed;
unsigned int(32) stereo_scheme;
unsigned int(32) length;
unsigned int(8)[length] stereo_indication_type;
Box[ ] any_box; // optional
}

### Semantics

single-view_allowed is an integer. A zero value indicates that the content may only be displayed on stereoscopic displays. When (single_view_allowed& 1) is equal to 1, it is allowed to display the right view on a monoscopic single-view display. When (single_view_allowed & 2) is equal to 2, it is allowed to display the left view on a monoscopic single-view display.
stereo_scheme is an integer that indicates the stereo arrangement scheme used and the stereo indication type according to the used scheme. The following values for stereo_scheme are specified:
   1: the frame packing scheme as specified by the Frame packing arrangement Supplemental
Enhancement Information message of [ITU-T H.265]
length indicates the number of bytes for the stereo-indication_type field.
stereo indication-type indicates the stereo arrangement type according to the used stereo indication scheme. The syntax and semantics of stereo_indication_type depend on the value of stereo_scheme. The syntax and semantics for stereo_indication_type for the following values of stereo_scheme are specified as follows:
   stereo scheme equal to 1: The value of length shall be 4 and stereo_indication-type shall be unsigned int(32) which contains the frame_packing_arrangement_type value from Table D-8 of [ITU-T H.265] (‘Definition of frame_packing_arrangement_type’).

Table D-8 of ITU-T H.265 is illustrated in Table 1:

TABLE 1

| Value | Interpretation |
|---|---|
| 3 | Each component plane of the decoded frames contains a side- |
| | by-side packing arrangement of corresponding planes of two |
| | constituent frames . . . |
| 4 | Each component plane of the decoded frames contains a top- |
| | bottom packing arrangement of corresponding planes of two |
| | constituent frames . . . |
| 5 | The component planes of the decoded frames in output order |
| | form a temporal interleaving of alternating first and second |
| | constituent frames . . . |

As described above, Choi specifies how to encapsulate, signal, and stream omnidirectional media using dynamic adaptive streaming over Hypertext Transfer Protocol (HTTP) (DASH). DASH is described in ISO/IEC: ISO/IEC 23009-1:2014, “Information technology—Dynamic adaptive streaming over HTTP (DASH)—Part 1: Media presentation description and segment formats,” International Organization for Standardization, 2nd Edition, May 15, 2014 (hereinafter, “ISO/IEC 23009-1:2014”), which is incorporated by reference herein. A DASH media presentation may include data segments, video segments, and audio segments. In some examples, a DASH Media Presentation may correspond to a linear service or part of a linear service of a given duration defined by a service provider (e.g., a single TV program, or the set of contiguous linear TV programs over a period of time). According to DASH, a Media Presentation Description (MPD) is a document that includes metadata required by a DASH Client to construct appropriate HTTP-URLs to access segments and to provide the streaming service to the user. A MPD document fragment may include a set of eXtensible Markup Language (XML)-encoded metadata fragments. The contents of the MPD provide the resource identifiers for segments and the context for the identified resources within the Media Presentation. The data structure and semantics of the MPD fragment are described with respect to ISO/IEC 23009-1:2014. Further, it should be noted that draft editions of ISO/IEC 23009-1 are currently being proposed. Thus, as used herein, a MPD may include a MPD as described in ISO/IEC 23009-1:2014, currently proposed MPDs, and/or combinations thereof. In ISO/IEC 23009-1:2014, a media presentation as described in a MPD may include a sequence of one or more Periods, where each Period may include one or more Adaptation Sets. It should be noted that in the case where an Adaptation Set includes multiple media content components, then each media content component may be described individually. Each Adaptation Set may include one or more Representations. In ISO/IEC 23009-1:2014 each Representation is provided: (1) as a single Segment, where Subsegments are aligned across Representations with an Adaptation Set; and (2) as a sequence of Segments where each Segment is addressable by a template-generated Universal Resource Locator (URL). The properties of each media content component may be described by an AdaptationSet element and/or elements within an Adaption Set, including for example, a ContentComponent element. DASH currently does not support where MPDs includes (1) metadata specifying the projection format of the projected frame; (2) metadata specifying the area of the spherical surface covered by the projected frame; (3) metadata specifying the orientation of the projection structure corresponding to the projected frame in a global coordinate system; (4) metadata specifying region-wise packing information; and (5) metadata specifying optional region-wise quality ranking.

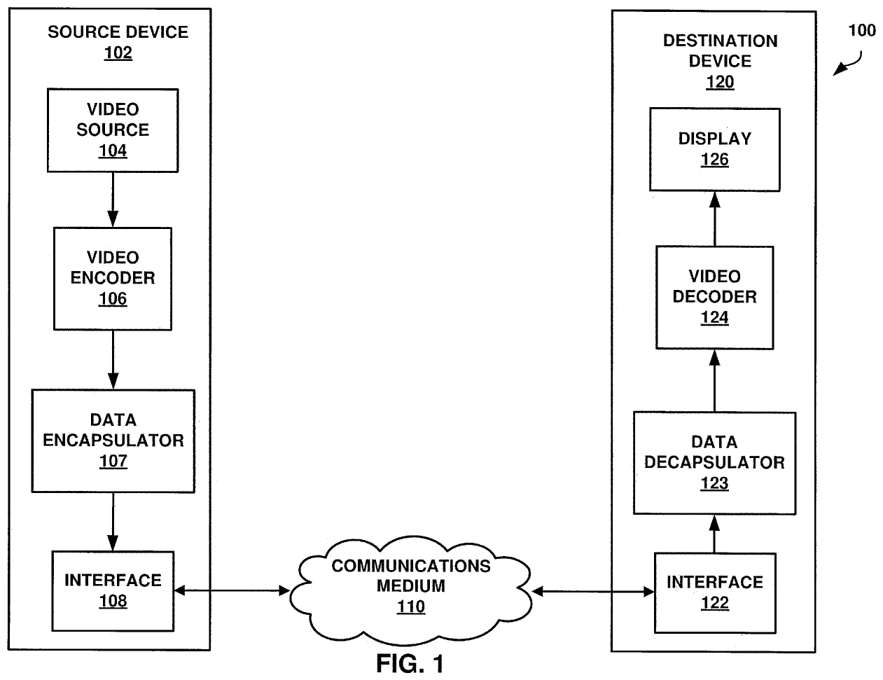

FIG. 1 is a block diagram illustrating an example of a system that may be configured to code (i.e., encode and/or decode) video data according to one or more techniques of this disclosure. System 100 represents an example of a system that may encapsulate video data according to one or more techniques of this disclosure. As illustrated in FIG. 1, system 100 includes source device 102, communications medium 110, and destination device 120. In the example illustrated in FIG. 1, source device 102 may include any device configured to encode video data and transmit encoded video data to communications medium 110. Destination device 120 may include any device configured to receive encoded video data via communications medium 110 and to decode encoded video data. Source device 102 and/or destination device 120 may include computing devices equipped for wired and/or wireless communications and may include, for example, set top boxes, digital video recorders, televisions, desktop, laptop or tablet computers, gaming consoles, medical imagining devices, and mobile devices, including, for example, smartphones, cellular telephones, personal gaming devices.

Communications medium 110 may include any combination of wireless and wired communication media, and/or storage devices. Communications medium 110 may include coaxial cables, fiber optic cables, twisted pair cables, wireless transmitters and receivers, routers, switches, repeaters, base stations, or any other equipment that may be useful to facilitate communications between various devices and sites. Communications medium 110 may include one or more networks. For example, communications medium 110 may include a network configured to enable access to the World Wide Web, for example, the Internet. A network may operate according to a combination of one or more telecommunication protocols. Telecommunications protocols may include proprietary aspects and/or may include standardized telecommunication protocols. Examples of standardized telecommunications protocols include Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, Global System Mobile Communications (GSM) standards, code division multiple access (CDMA) standards, 3rd Generation Partnership Project (3GPP) standards, European Telecommunications Standards Institute (ETSI) standards, Internet Protocol (IP) standards, Wireless Application Protocol (WAP) standards, and Institute of Electrical and Electronics Engineers (IEEE) standards.

Storage devices may include any type of device or storage medium capable of storing data. A storage medium may include a tangible or non-transitory computer-readable media. A computer readable medium may include optical discs, flash memory, magnetic memory, or any other suitable digital storage media. In some examples, a memory device or portions thereof may be described as non-volatile memory and in other examples portions of memory devices may be described as volatile memory. Examples of volatile memories may include random access memories (RAM), dynamic random access memories (DRAM), and static random access memories (SRAM). Examples of non-volatile memories may include magnetic hard discs, optical discs, floppy discs, flash memories, or forms of electrically programmable memories (EPROM) or electrically erasable and programmable (EEPROM) memories. Storage device(s) may include memory cards (e.g., a Secure Digital (SD) memory card), internal/external hard disk drives, and/or internal/external solid state drives. Data may be stored on a storage device according to a defined file format.

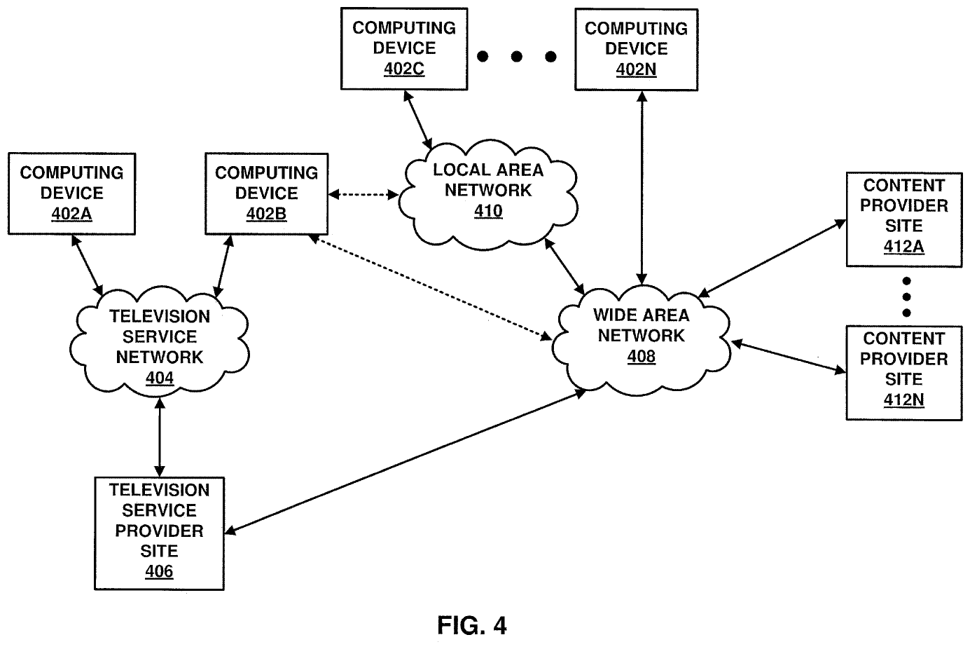

FIG. 4 is a conceptual drawing illustrating an example of components that may be included in an implementation of system 100. In the example implementation illustrated in FIG. 4, system 100 includes one or more computing devices 402A-402N, television service network 404, television service provider site 406, wide area network 408, local area network 410, and one or more content provider sites 412A-412N. The implementation illustrated in FIG. 4 represents an example of a system that may be configured to allow digital media content, such as, for example, a movie, a live sporting event, etc., and data and applications and media presentations associated therewith to be distributed to and accessed by a plurality of computing devices, such as computing devices 402A-402N. In the example illustrated in FIG. 4, computing devices 402A-402N may include any device configured to receive data from one or more of television service network 404, wide area network 408, and/or local area network 410. For example, computing devices 402A-402N may be equipped for wired and/or wireless communications and may be configured to receive services through one or more data channels and may include televisions, including so-called smart televisions, set top boxes, and digital video recorders. Further, computing devices 402A-402N may include desktop, laptop, or tablet computers, gaming consoles, mobile devices, including, for example, “smart” phones, cellular telephones, and personal gaming devices.

Television service network 404 is an example of a network configured to enable digital media content, which may include television services, to be distributed. For example, television service network 404 may include public over-the-air television networks, public or subscription-based satellite television service provider networks, and public or subscription-based cable television provider networks and/or over the top or Internet service providers. It should be noted that although in some examples television service network 404 may primarily be used to enable television services to be provided, television service network 404 may also enable other types of data and services to be provided according to any combination of the telecommunication protocols described herein. Further, it should be noted that in some examples, television service network 404 may enable two-way communications between television service provider site 406 and one or more of computing devices 402A-402N. Television service network 404 may comprise any combination of wireless and/or wired communication media. Television service network 404 may include coaxial cables, fiber optic cables, twisted pair cables, wireless transmitters and receivers, routers, switches, repeaters, base stations, or any other equipment that may be useful to facilitate communications between various devices and sites. Television service network 404 may operate according to a combination of one or more telecommunication protocols. Telecommunications protocols may include proprietary aspects and/or may include standardized telecommunication protocols. Examples of standardized telecommunications protocols include DVB standards, ATSC standards, ISDB standards, DTMB standards, DMB standards, Data Over Cable Service Interface Specification (DOCSIS) standards, HbbTV standards, W3C standards, and UPnP standards.

Referring again to FIG. 4, television service provider site 406 may be configured to distribute television service via television service network 404. For example, television service provider site 406 may include one or more broadcast stations, a cable television provider, or a satellite television provider, or an Internet-based television provider. For example, television service provider site 406 may be configured to receive a transmission including television programming through a satellite uplink/downlink. Further, as illustrated in FIG. 4, television service provider site 406 may be in communication with wide area network 408 and may be configured to receive data from content provider sites 412A-412N. It should be noted that in some examples, television service provider site 406 may include a television studio and content may originate therefrom.

Wide area network 408 may include a packet based network and operate according to a combination of one or more telecommunication protocols. Telecommunications protocols may include proprietary aspects and/or may include standardized telecommunication protocols. Examples of standardized telecommunications protocols include Global System Mobile Communications (GSM) standards, code division multiple access (CDMA) standards, 3^{rd} Generation Partnership Project (3GPP) standards, European Telecommunications Standards Institute (ETSI) standards, European standards (EN), IP standards, Wireless Application Protocol (WAP) standards, and Institute of Electrical and Electronics Engineers (IEEE) standards, such as, for example, one or more of the IEEE 802 standards (e.g., Wi-Fi). Wide area network 408 may comprise any combination of wireless and/or wired communication media. Wide area network 480 may include coaxial cables, fiber optic cables, twisted pair cables, Ethernet cables, wireless transmitters and receivers, routers, switches, repeaters, base stations, or any other equipment that may be useful to facilitate communications between various devices and sites. In one example, wide area network 408 may include the Internet. Local area network 410 may include a packet based network and operate according to a combination of one or more telecommunication protocols. Local area network 410 may be distinguished from wide area network 408 based on levels of access and/or physical infrastructure. For example, local area network 410 may include a secure home network.

Referring again to FIG. 4, content provider sites 412A-412N represent examples of sites that may provide multimedia content to television service provider site 406 and/or computing devices 402A-402N. For example, a content provider site may include a studio having one or more studio content servers configured to provide multimedia files and/or streams to television service provider site 406. In one example, content provider sites 412A-412N may be configured to provide multimedia content using the IP suite. For example, a content provider site may be configured to provide multimedia content to a receiver device according to Real Time Streaming Protocol (RTSP), HTTP, or the like. Further, content provider sites 412A-412N may be configured to provide data, including hypertext based content, and the like, to one or more of receiver devices computing devices 402A-402N and/or television service provider site 406 through wide area network 408. Content provider sites 412A-412N may include one or more web servers. Data provided by data provider site 412A-412N may be defined according to data formats.

Referring again to FIG. 1, source device 102 includes video source 104, video encoder 106, data encapsulator 107, and interface 108. Video source 104 may include any device configured to capture and/or store video data. For example, video source 104 may include a video camera and a storage device operably coupled thereto. Video encoder 106 may include any device configured to receive video data and generate a compliant bitstream representing the video data. A compliant bitstream may refer to a bitstream that a video decoder can receive and reproduce video data therefrom. Aspects of a compliant bitstream may be defined according to a video coding standard. When generating a compliant bitstream video encoder 106 may compress video data. Compression may be lossy (discernible or indiscernible to a viewer) or lossless.

Referring again to FIG. 1, data encapsulator 107 may receive encoded video data and generate a compliant bitstream, e.g., a sequence of NAL units according to a defined data structure. A device receiving a compliant bitstream can reproduce video data therefrom. It should be noted that the term conforming bitstream may be used in place of the term compliant bitstream. It should be noted that data encapsulator 107 need not necessary be located in the same physical device as video encoder 106. For example, functions described as being performed by video encoder 106 and data encapsulator 107 may be distributed among devices illustrated in FIG. 4.

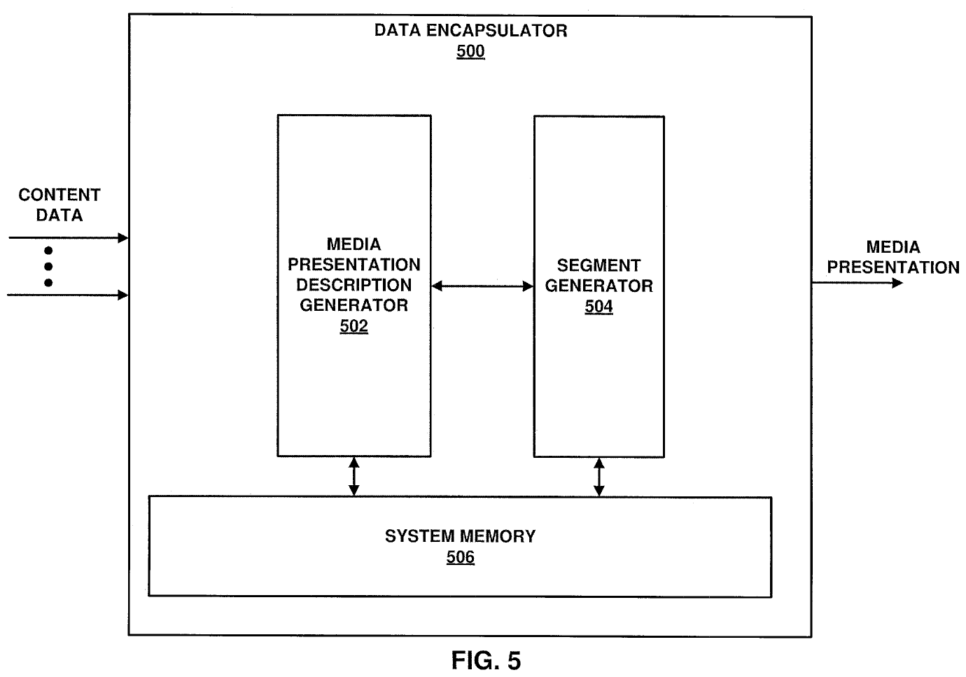

In one example, data encapsulator 107 may include a data encapsulator configured to receive one or more media components and generate media presentation based on DASH. FIG. 5 is a block diagram illustrating an example of a data encapsulator that may implement one or more techniques of this disclosure. Data encapsulator 500 may be configured to generate a media presentation according to the techniques described herein. In the example illustrated in FIG. 5, functional blocks of component encapsulator 500 correspond to functional blocks for generating a media presentation (e.g., a DASH media presentation). As illustrated in FIG. 5, component encapsulator 500 includes media presentation description generator 502, segment generator 504, and system memory 506. Each of media presentation description generator 502, segment generator 504, and system memory 506 may be interconnected (physically, communicatively, and/or operatively) for inter-component communications and may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof. It should be noted that although data encapsulator 500 is illustrated as having distinct functional blocks, such an illustration is for descriptive purposes and does not limit data encapsulator 500 to a particular hardware architecture. Functions of data encapsulator 500 may be realized using any combination of hardware, firmware and/or software implementations.

Media presentation description generator 502 may be configured to generate media presentation description fragments. Segment generator 504 may be configured to receive media components and generate one or more segments for inclusion in a media presentation. System memory 506 may be described as a non-transitory or tangible computer-readable storage medium. In some examples, system memory 506 may provide temporary and/or long-term storage. In some examples, system memory 506 or portions thereof may be described as non-volatile memory and in other examples portions of system memory 506 may be described as volatile memory. System memory 506 may be configured to store information that may be used by data encapsulator during operation.

As described above, DASH currently does not support where MPDs includes (1) metadata specifying the projection format of the projected frame; (2) metadata specifying the area of the spherical surface covered by the projected frame; (3) metadata specifying the orientation of the projection structure corresponding to the projected frame in a global coordinate system; (4) metadata specifying region-wise packing information; and (5) metadata specifying optional region-wise quality ranking. In one example, media presentation description generator 502 may be configured to generate a MPD that includes (1) metadata specifying the projection format of the projected frame; (2) metadata specifying the area of the spherical surface covered by the projected frame; (3) metadata specifying the orientation of the projection structure corresponding to the projected frame in a global coordinate system; (4) metadata specifying region-wise packing information; and/or (5) metadata specifying optional region-wise quality ranking.

In one example, media presentation description generator 502 may be configured to generate a projection format (PF) descriptor including metadata describing geometry type and/or projection type information. In one example, a projection format descriptor may be based on the following example definition:
The projection format (PF) descriptor may be present as a SupplementalProperty (or EssentialProperty descriptor) child element in Period and/or AdaptationSet, and/or Representation, and/or SubRepresentation element.
In one example the projection format (PF) descriptor shall be present as an EssentialProperty descriptor.
The PF descriptor is a SupplementalProperty (and/or EssentialProperty) descriptor with @schemeldUri equal to “urn:mpeg:mpegB:cicp:PF”. An EssentialProperty descriptor should be used when displaying the decoded video content on a two dimensional display is undesirable without projection-aware display processing.
When a PF descriptor element with a particular @schemeldUri attribute is included at Period level (i.e. in a Period element) and/or at Adaptation Set level (i.e. in a AdaptationSet element) and/or at a Representation (i.e. in a Representation element), and/or at a sub representation (i.e. in a SubRepresentation element) the value (i.e. @value) signaled in the PF descriptor at the hierarchically lower level shall take precedence over the value (i.e. @value) signaled at higher level.

In one example, the @value of the SupplementalProperty or EssentialProperty elements using the PF scheme with @CschemeldUri equal to “urn:mpeg:mpegB:cicp:PF” may be a comma separated list of values and may be specified based on the example illustrated in Table 2A. It should be noted that in the Tables below, for Use, M=Mandatory and O=Optional.

TABLE 2

| @value parameter | | |
|---|---|---|
| for PF | | |
| SupplementalProperty/ | | |
| EssentialProperty | Use | Description |
| projection_type | M | Specifies the projection type of the |
| | | projected frame. |
| | | For ISO base media file format |
| | | Segments, projection_type shall be |
| | | equal to projection_type in |
| | | ProjectionFormatBox as described |
| | | in Choi. In one example the |
| | | ProjectionFormatBox shall be the one |
| | | in the Initialization |
| | | Segment. |
| geometry_type | O | Specifies the geometry type of the |
| | | projected frame. |
| | | For ISO base media file format |
| | | Segments, geometry_type shall be |
| | | equal to geometry_type in |
| | | ProjectionFormatBox as described |
| | | in Choi. In one example the |
| | | ProjectionFormatBox shall be the one |
| | | in the Initialization Segment. |
| | | When geometry_type is not present it |
| | | shall be inferred to be equal to 1 |
| | | which indicates projection indicator |
| | | is given in spherical co-ordinates. |

In one example, only the projection_type is signaled in @value.

In one example a list of projection_type values may be signaled as shown in the example illustrated in Table 2 B below.

An Essential Property projection format (PF) descriptor element with a @ schemeldUri attribute equal to “un:mpeg:mpegB:cicp:PF” may be present at MPD level and/or at adaptation set level (i.e. in a AdaptationSet element) and/or at a representation level (i.e. in a Representation element). The @value of the PF descriptor with @ schemeldUri equal to “urn:mpeg:mpegB:cicp:PF” is a comma separated list of values as specified in the following table:

TABLE 2B

| @value parameter | | |
|---|---|---|
| for PF | | |
| descriptor | Use | Description |
| projection_type | M | Specifies a comma separated list of projection |
| | | type values of the projected frame. |
| | | For ISO base media file format Segments, each |
| | | value in the list projection_type shall be |
| | | equal to allowed projection_type in |
| | | ProjectionFormatBox as described in ISO/IEC |
| | | 23000-20 OMAF of the Initialization Segment. |

In one example, only the projection_type is signaled in @value and additionally the descriptor may be preferably signalled as a SupplementalProperty descriptor child element in Period element. In this example, the @ value of the SupplementalProperty or EssentialProperty elements using the PF scheme with @schemeIdUri equal to “urn:mpeg:mpegB:cicp:PF” may be a comma separated list of values and may be specified based on the example illustrated in Table 3:

TABLE 3

| @value parameter | | |
|---|---|---|
| for PF | | |
| SupplementalProperty/ | | |
| EssentialProperty | Use | Description |
| projection_type | M | specifies the projection type of the |
| | | projected frame. |
| | | For ISO base media file format |
| | | Segments, projection_type shall be |
| | | equal to projection_type in |
| | | ProjectionFormatBox as described |
| | | in Choi. In one example the |
| | | ProjectionFormatBox shall be the |
| | | one in the Initialization Segment. |
| id_list | O | id_list specifies a space separated |
| | | list of AdaptationSet@id and/or |
| | | Representation@id and/or |
| | | subRepresentation@id values to |
| | | which the indicated projection_type |
| | | signalled in the first parameter applies. |
| | | In this case each AdaptationSet@id, |
| | | Representation@id and |
| | | subRepresentation@id values shall |
| | | be different than each other in a Period |
| | | element. |
| | | In another example id_list specifies a |
| | | space separated list of AdaptationSet@id |
| | | value prefixed with “A”, and/or |
| | | Representation@id value prefixed with |
| | | “R”, and/or subRepresentation@id |
| | | value prefixed with “S” to which the |
| | | indicated projection_type signalled in the |
| | | first parameter applies. |

With respect to Table 3, in one example the following rules may apply:
If no id list parameter is present and the descriptor is a child element of Period element then the projection_type applies to all the child AdaptationSet, Representation, SubRepresentation elements of the Period element which does not include the PF descriptor as its child element.
More than one PF descriptor element as a SupplementalProperty with @schemeldUri equal to “urn:mpeg:mpegB:cicp:PF” may be included as a child element of Period element. In this case @value for each of these PD descriptors shall be different.

In one example, the entire contents of ProjectionFormatBox are signaled in @value. Additionally, in this example, the descriptor may be preferably signalled as a SupplementalProperty descriptor child element in Period element. In this example, the @value of the SupplementalProperty or EssentialProperty elements using the PF scheme with @schemeldUri equal to “urn:mpeg:mpegB:cicp:PF” may be a comma separated list of values and may be specified based on the example illustrated in Table 4A:

TABLE 4A

| @value parameter | | |
|---|---|---|
| for PF | | |
| SupplementalProperty/ | | |
| EssentialProperty | Use | Description |
| projection_type | M | specifies the projection type of the |
| | | projected frame. |
| | | For ISO base media file format |
| | | Segments, projection_type shall be |
| | | equal to projection_type in |
| | | ProjectionFormatBox as described |
| | | in Choi. In one example the |
| | | ProjectionFormatBox shall be the |
| | | one in the Initialization Segment. |
| id_list | O | id_list specifies a space separated |
| | | list of AdaptationSet@id and/or |
| | | Representation@id and/or |
| | | SubRepresentation@id values to |
| | | which the indicated information |
| | | signalled in the first parameter |
| | | (ProjectionFormatBox) applies. |
| | | In this case each AdaptationSet@id, |
| | | Representation@id and |
| | | SubRepresentation@id values shall |
| | | be different than each other in a Period |
| | | element. |
| | | In another example id_list specifies |
| | | a space separated list of AdaptationSet@id |
| | | value prefixed with “A”, and/or |
| | | Representation@id value prefixed with |
| | | “R”, and/or SubRepresentation@id |
| | | value prefixed with “S” to which the |
| | | indicated projection_type signalled in the |
| | | first parameter applies. |

Referring to Table 4A, in one example, the following rules may apply:
If no id_list parameter is present and the descriptor is a child element of Period element then the projection_type applies to all the child AdaptationSet, Representation, subRepresentation elements of the Period element which does not include the PF descriptor as its child element.
More than one PF descriptor element as a SupplementalProperty with @schemeldUri equal to “urn:mpeg:mpegB:cicp:PF” may be included as a child element of Period element. In this case, the @value for each of these PF descriptors shall be different.

In one example, the projection format (PF) descriptor may be present as a SupplementalProperty (or EssentialProperty descriptor) child element in Period or AdaptationSet, or Representation, or SubRepresentation element with @schemeldUri equal to “urn:mpeg:mpegB:cicp:PF”. In one example, when a PF descriptor element with a @schemeldUri attribute equal to “urn:mpeg:mpegB:cicp:PF” is included at period level (i.e. in a Period element) and/or at adaptation set level (i.e. in a AdaptationSet element) and/or at a representation (i.e. in a Representation element), and/or at a sub representation (i.e. in a SubRepresentation element) the @value signaled in the PF descriptor at the hierarchically lower level shall take precedence over the @value signaled at higher level. In one example, multiple PF descriptor elements with @schemeldUri attribute equal to “urn:mpeg:mpegB:cicp:PF” may be present in which case they shall have different @value and id_list shall be included in @value. In example, the @value of the PF descriptor with @schemeldUri equal to “urn:mpeg:mpegB:cicp:PF” is a space separated list of values and may be specified based on the example illustrated in Table 4B:

TABLE 4B

| @value parameter | | |
|---|---|---|
| for PF | | |
| descriptor | Use | Description |
| projection_type | M | Specifies the projection type of |
| | | the projected frame. |
| | | For ISO base media file format |
| | | Segments, projection_type shall |
| | | be equal to projection_type in |
| | | ProjectionFormatBox as described |
| | | in Choi of the Initialization |
| | | Segment. |
| geometry_type | O | Specifies the geometry type of |
| | | the projected frame. |
| | | For ISO base media file format |
| | | Segments, geometry_type shall |
| | | be equal to geometry_type in |
| | | ProjectionFormatBox as |
| | | described in Choi of the |
| | | Initialization Segment. |
| | | When geometry_type is not |
| | | present it shall be inferred |
| | | to be equal to 1, which indicates |
| | | projection indicator is specified |
| | | in spherical co-ordinates. |
| id_list | O | Option 1: Specifies a comma- |
| | | separated list of |
| | | AdaptationSet@id and |
| | | Representation@id and |
| | | SubRepresentation@id values |
| | | to which the indicated information |
| | | signalled in this descriptor |
| | | applies. When id_list is present, |
| | | each AdaptationSet@id, |
| | | Representation@id and |
| | | subRepresentation@id value |
| | | shall be different than each other |
| | | in a Period element. |
| | | Option 2: Specifies a comma separated |
| | | list of AdaptationSet@id value |
| | | prefixed with “A”, and |
| | | Representation@id value prefixed |
| | | with “R”, and SubRepresentation@id |
| | | value prefixed with “S” to which |
| | | the indicated information signalled in |
| | | this descriptor applies. |
| | | For both Option 1, Option 2: |
| | | When id_list is present, geometry_type |
| | | shall be present. |
| | | If id_list is not present the |
| | | information signalled in this descriptor |
| | | applies to that element and any child |
| | | AdaptationSet, or Representation, or |
| | | SubRepresentation elements which do not |
| | | have a PF descriptor (or FV descriptor) |
| | | signaled with an id value in id_list |
| | | that matches its @id. |

In one example, media presentation description generator 502 may be configured to generate a fish eye omnidirectional video information descriptor including metadata describing fisheye omnidirectional video content. In one example, a fish eye omnidirectional video information descriptor may be based on the following example definition:
The fisheye omnidirectional video information (FV) descriptor may be present as a SupplementalProperty (or EssentialProperty descriptor) child element in Period or AdaptationSet, or Representation, or SubRepresentation element with @schemeIdUri equal to “urn:mpeg:dash:fv:2017”.
In one example, the fisheye omnidirectional video information (FV) descriptor shall be present as an EssentialProperty descriptor
The FV descriptor is a SupplementalProperty (and/or EssentialProperty) descriptor with @schemeIdUri equal to “urn:mpeg:dash:fv:2017”. An EssentialProperty descriptor should be used when displaying the decoded video content on a two dimensional display is undesirable without projection-aware display processing.
When a FV descriptor element with a @schemeldUri attribute equal to “urn:mpeg:dash:fv:2017” is included at period level (i.e. in a Period element) and/or at adaptation set level (i.e. in a AdaptationSet element) and/or at a representation (i.e. in a Representation element), and/or at a sub representation (i.e. in a SubRepresentation element) the @value signaled in the FV descriptor at the hierarchically lower level shall take precedence over the @value signaled at higher level.
Multiple FV descriptor elements with @schemeldUri attribute equal to “urn:mpeg:dash:fv:2017” may be present in which case they shall have different @value and id_list shall be included in @value.
Additionally this descriptor may be preferably signalled as a SupplementalProperty descriptor child element in Period element.

In one example, the @value of the FV descriptor with @schemeldUri equal to “urn:mpeg:dash:fv:2017” may be a space separated list of values as specified in Table 5:

TABLE 5

| @value parameter | | |
|---|---|---|
| for FV | | |
| SupplementalProperty/ | | |
| EssentialProperty | Use | Description |
| FisheyeOmnidirectional | M | Specifies that the associated |
| VideoBox | | content contains multiple |
| | | circular images captured by |
| | | fisheye cameras and provides |
| | | fisheye omnidirectional video |
| | | information. |
| | | For ISO base media file format |
| | | Segments, |
| | | fisheye_omnidirectional_video_box |
| | | shall be equal to contents of |
| | | FisheyeOmnidirectionalVideoBox as |
| | | described in Choi of the |
| | | Initialization Segment. |
| | | The binary data content of |
| | | FisheyeOmnidirectionalVideoBox |
| | | shall be coded to string format |
| | | in parameter |
| | | fisheye_omnidirectional_video_box |
| | | using Base64 encoding |
| id_list | O | Option 1: Specifies a comma-separated |
| | | list of AdaptationSet@id and |
| | | Representation@id and |
| | | SubRepresentation@id values to |
| | | which the indicated fisheye video |
| | | information signalled in this descriptor |
| | | applies. When id_list is present, each |
| | | AdaptationSet@id, Representation@id |
| | | and subRepresentation@id value shall |
| | | be different than each other in a |
| | | Period element. |
| | | Option 2: Specifies a comma separated |
| | | list of AdaptationSet@id value |
| | | prefixed with “A”, and |
| | | Representation@id value prefixed |
| | | with “R”, and SubRepresentation@id |
| | | value prefixed with “S” to which |
| | | the indicated fisheye video information |
| | | signalled in this descriptor applies. |
| | | For both Option 1, Option 2: |
| | | When id_list is present, geometry_type |
| | | shall be present. |
| | | If id_list is not present the fisheye |
| | | video information signalled in this |
| | | descriptor applies to that element and |
| | | any child AdaptationSet, or |
| | | Representation, or SubRepresentation |
| | | elements which do not |
| | | have a FV descriptor (or PF descriptor) |
| | | signaled with an id value in id_list |
| | | that matches its @id. |

Referring to Table 5, in one example, the following rules may apply:
If no id_list parameter is present and the descriptor is a child element of Period element then the projection_type applies to all the child AdaptationSet, Representation, subRepresentation elements of the Period element which does not include the PF descriptor as its child element.
More than one PF descriptor element as a SupplementalProperty with @schemeldUri equal to “urn:mpeg:mpegB:cicp:PF” may be included as a child element of Period element. In this case the value of the first parameter FisheyeOmnidirectionalVideoBox for each of FV descriptor shall be different.

Referring to Tables 2A-2B, 3, 4A, 4B, and 5, in one example, the following rules may apply:
Each Representation and/or subRepresentation shall only include (or inherit from parent AdaptationSet element either a PF or a FV descriptor but not both.

In one example, media presentation description generator 502 may be configured to generate a stereo frame packing information descriptor including metadata that indicates that a projected frame represents stereoscopic content. The stereo frame packing information (SFP) descriptor indicates that the projected frame represents stereoscopic content. The DASH FramePacking element may be used for stereo frame packing information (SFP) descriptor.

In one example, a stereo frame packing information (SFP) descriptor may be based on the following example definition:
The SFP descriptor is a SupplementalProperty (and/or EssentialProperty) descriptor with @schemeldUri equal to “urn:mpeg:dash:23000:20:stereo:2017”.
In one example, for Adaptation Sets or Representations or Sub-Representations that contain a video component that conforms to ISO/IEC 23000-20 CD OMAF, the URI urn:mpeg:dash:23000:20:stereo:2017 shall be used.
In another example, for Adaptation Sets or Representations or Sub-Representations that contain a video component that conforms to ISO/JEC 23000-20 CD OMAF, the URI urn:mpeg:mpegB:cicp:VideoFramePackingType shall be used.
When a SFP descriptor element with a particular @schemeldUri attribute is included at Adaptation Set level (i.e. in a AdaptationSet element) and/or at a Representation (i.e. in a Representation element), and/or at a sub representation (i.e. in a SubRepresentation element) the @value signaled in the SFP descriptor at the hierarchically lower level shall take precedence over the @value signaled at higher level.
When a SFP descriptor is not included in and element or not inherited from parent element then the content of that element are monoscopic video.

In one example, the @value shall be equal to 3 or 4 with the meaning of those values as defined for in Table D-8 of ITU-T H.265. It should be noted that ISO/JEC 23001-8, Part 8, “Coding-independent code points,” 2013 Jul. 1, which is incorporated by reference, includes a VideoFramePackingType having values 3 and 4 with a similar meaning to like values in Table D-8 of ITU-T H.265.

In one example, the @value of the SFP descriptor with @schemeldUri equal to “urn:mpeg:dash:23000:20:stereo:2017” may be a space separated list of values as specified based on Table 6:

TABLE 6

| ©value parameter | | |
|---|---|---|
| for SFP | | |
| SupplementalProperty/ | | |
| EssentialProperty | Use | Description |
| FramePackingType | M | Specifies that the frame packing type |
| | | for the stereoscopic video. |
| | | This value shall be equal to 3 or 4 |
| | | with the meaning of those values as |
| | | defined for VideoFramePackingType |
| | | in ISO/IEC 23001-8. |
| id_list | O | Option 1: Specifies a comma-separated |
| | | list of AdaptationSet@id and |
| | | Representation@id and |
| | | SubRepresentation@id values to |
| | | which the indicated stereo frame |
| | | packing information signalled in this |
| | | descriptor applies. When id_list is |
| | | present, each AdaptationSet@id, |
| | | Representation@id and |
| | | subRepresentation@id value shall |
| | | be different than each other in a |
| | | Period element. |
| | | Option 2: Specifies a comma separated |
| | | list of AdaptationSet@id value |
| | | prefixed with “A”, and |
| | | Representation@id value prefixed |
| | | with “R”, and SubRepresentation@id |
| | | value prefixed with “S” to which |
| | | the indicated stereo frame packing |
| | | information signalled in this |
| | | descriptor applies. |
| | | For both Option 1, Option 2: |
| | | When id_list is present, geometry_type |
| | | shall be present. |
| | | If id_list is not present the stereo |
| | | frame packing information signalled in |
| | | this descriptor applies to that element |
| | | and any child AdaptationSet, or |
| | | Representation, or SubRepresentation |
| | | elements which do not havea SFP |
| | | descriptor signaled with an id value |
| | | in id_list that matches its @id. |

In one example, DASH FramePacking element shall be used for indicating that the projected frame represents stereoscopic content and for providing frame packing information and accordingly in one example, DASH FramePacking element may be based on the following definition:
For Adaptation Sets or Representations or SubRepresentations that contain a video component that conforms to ISO/JEC 23000-20 CD OMAF, the URI urn:mpeg:dash:23 000:20:stereo:2017 shall be used. The @value equal to 3 or 4 with the meaning of those values as defined for VideoFramePackingType in ISO/IEC 23001-8.

In one example, DASH FramePacking element may be based on the following definition:
For Adaptation Sets or Representations or SubRepresentations that contain a video component that conforms to ISO/IEC 23000-20 CD OMAF, the URI urn:mpeg:dash:23000:20: stereo:2017 shall be used.

In one example, the @value of the SupplementalProperty or EssentialProperty elements using the SFP scheme may be a comma separated list of values for SFP parameters specified based on the example illustrated in Table 7:

TABLE 7

| @value parameter | | |
|---|---|---|
| for SFP | | |
| SupplementalProperty/ | | |
| EssentialProperty | Use | Description |
| FramePackingType | M | specifies that the frame packing |
| | | type for the stereoscopic video. |
| | | This value equal to 3 or 4 with |
| | | the meaning of those values as defined |
| | | for VideoFramePackingType in ISO/IEC |
| | | 23001-8. |
| id_list | O | id_list specifies a space separated |
| | | list of AdaptationSet@id and/or |
| | | Representation@id and/or |
| | | SubRepresentation@id values to |
| | | which the indicated information |
| | | signalled in the first parameter |
| | | (FramePackingType) applies. |
| | | In this case each AdaptationSet@id, |
| | | Representation@id and |
| | | SubRepresentation@id |
| | | values shall be different than each |
| | | other in a Period element. |
| | | In another example id_list specifies a |
| | | space separated list of AdaptationSet@id |
| | | value prefixed with “A”, and/or |
| | | Representation@id value prefixed with |
| | | “R”, and/or SubRepresentation@id |
| | | value prefixed with “S” to which the |
| | | indicated FramePackingType signalled in |
| | | the first parameter applies. |

In one example, instead of URI urn:mpeg:dash:23000:20:stereo:2017, URI urn:mpeg:mpegB:cicp:VideoFramePackingType may be used.

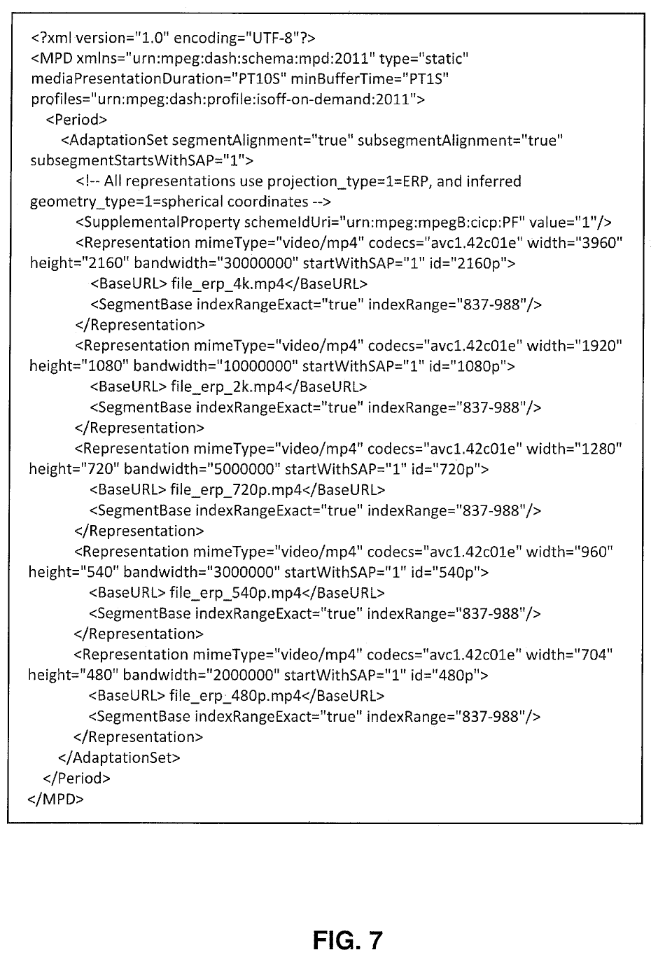

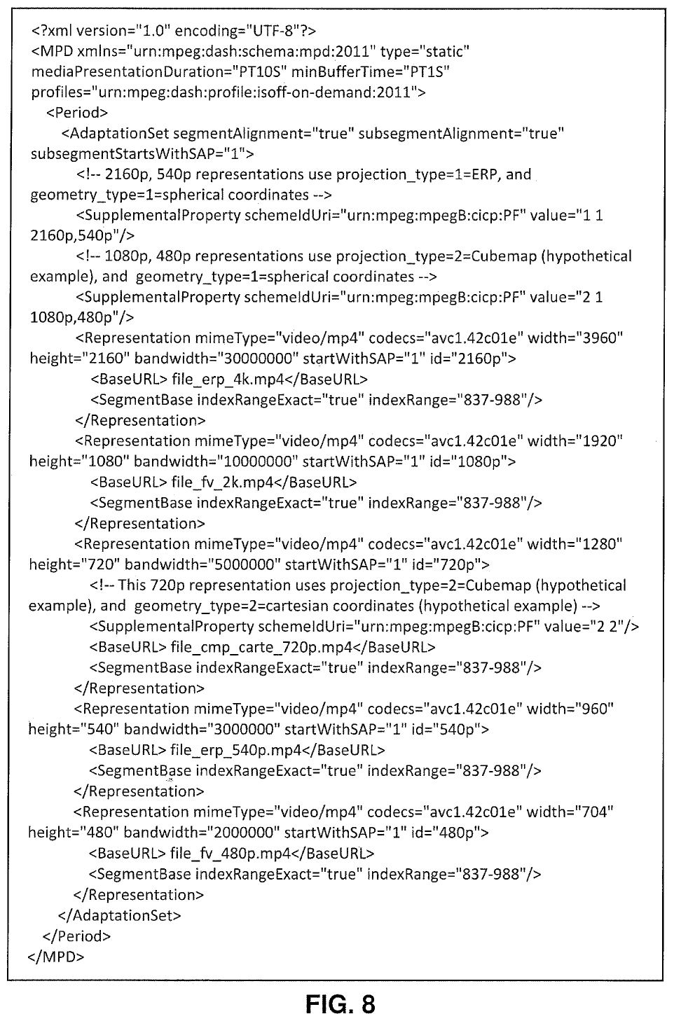

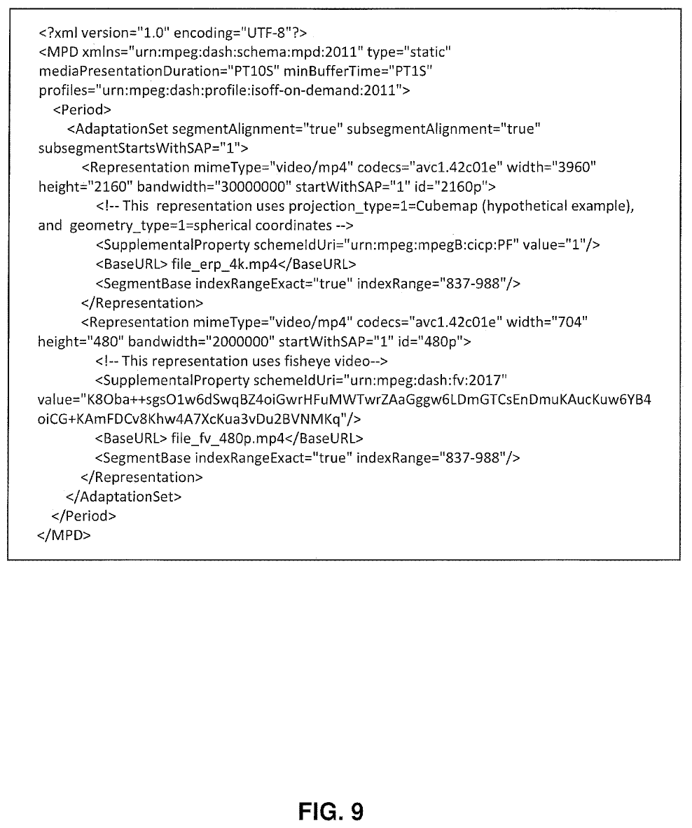

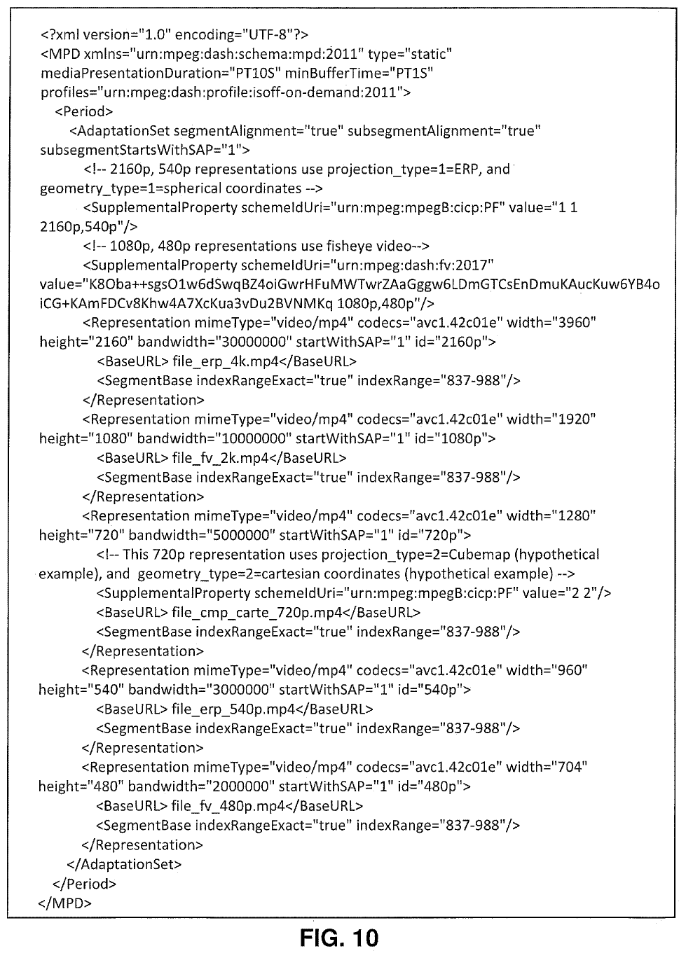

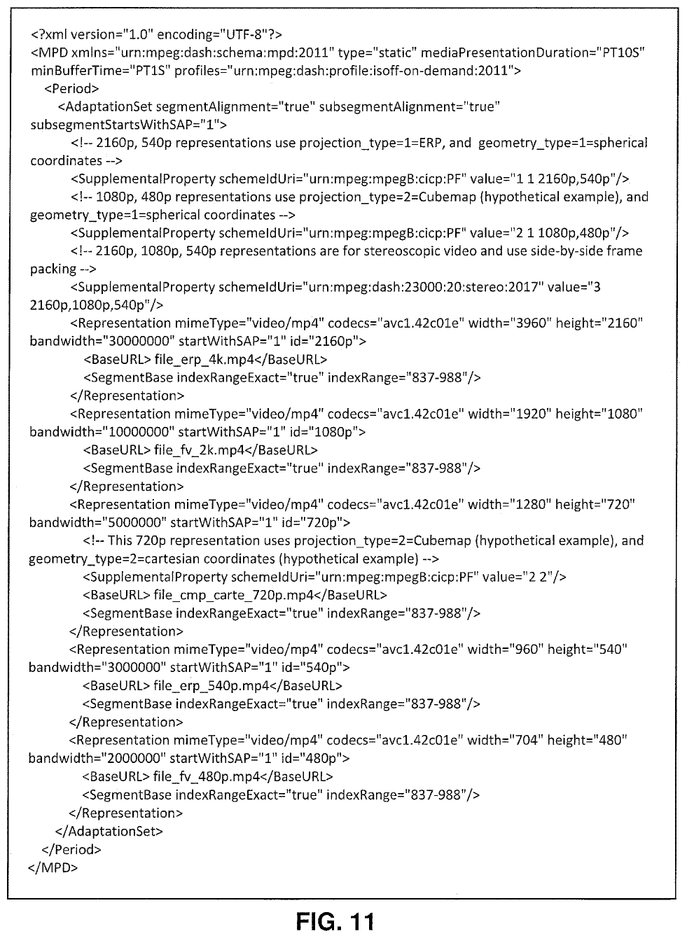

FIGS. 7-11 are computer programs listing illustrating an example of signaling meta data according to one or more techniques of this disclosure. Each of FIGS. 7-11 illustrate MPD example snippets including PF, FV and SFP descriptors. In the example illustrated in FIG. 7, all representations use the same projection_type and geometry-type. In the example illustrated in FIG. 8, two representations use Equirectangular projection (ERP) and spherical coordinates, two other representations use Cubemap (hypothetical example) and spherical coordinates and one representation uses Cubemap (hypothetical example) and cartesian coordinates (hypothetical example). It should be noted that a Cubemap uses six faces of a cube as a map shape. In the example illustrated in FIG. 9, one representation is fisheye video and the other representation is using ERP and spherical coordinates. In the example illustrated in FIG. 10, two representations are fisheye videos, two other representations use use ERP and spherical coordinates and one representation uses Cubemap (hypothetical example) and cartesian coordinates (hypothetical example). In the example illustrated in FIG. 11, two representations use ERP and spherical coordinates, two other representations use Cubemap (hypothetical example) and spherical coordinates and one representation uses Cubemap (hypothetical example) and cartesian coordinates (hypothetical example). Also three of the representations are stereoscopic video with side-by-side frame packing. The other two representations are for monoscopic video.

In one example, media presentation description generator 502 may be configured to generate a region-wise packing (RWP) descriptor including information regarding how projected frames are packed region-wise and how they should be unpacked before rendering. In one example, a region-wise packing (RWP) descriptor may be based on the following example definition:
The region-wise packing (RWP) descriptor may be present as a SupplementalProperty or EssentialProperty descriptor child element in Period and/or AdaptationSet, and/or Representation, and/or SubRepresentation element.
In one example the region-wise packing (RWP) descriptor shall be present as an EssentialProperty descriptor
The RWP descriptor is a SupplementalProperty (and/or EssentialProperty) descriptor with @schemeldUri equal to “urn:mpeg:mpegB:cicp:RWP”. An EssentialProperty descriptor should be used when displaying the decoded video content on a 2 dimensional display is undesirable without unpacking before rendering and display processing.

In one example, the @value of the SupplementalProperty or EssentialProperty elements using the RWP scheme with @schemeldUri equal to “urn:mpeg:mpegB:cicp:RWP” may be a comma separated list of values specified based on the example illustrated in Table 8A:

TABLE 8A

| @value parameter | | |
|---|---|---|
| for RWP | | |
| SupplementalProperty/ | | |
| EssentialProperty | Use | Description |
| rwpk | M | specifies the region-wise packing |
| | | information regarding how projected |
| | | frames are packed. |
| | | For ISO base media file format |
| | | Segments, rwpk shall be equal to |
| | | contents of RegionWisePackingBox |
| | | as described in ISO/IEC 23000-20 |
| | | OMAF. |
| | | In one example the |
| | | RegionWisePackingBox shall be the |
| | | one in the Initialization Segment. |
| | | In one example the binary data |
| | | content of RegionWisePackingBox |
| | | shall be coded to String format |
| | | using Base64 encoding. |

Further, in one example media presentation description generator 502 may be configured to generate a region-wise packing (RWP) descriptor based on the following example definition:
A EssentialProperty Region-wise packing format (RWPK) descriptor element with a @schemeldUri attribute equal to “urn:mpeg:dash:rwpk:2017” may be present at MPD level and/or at adaptation set level (i.e. in a AdaptationSet element) and/or at a representation level (i.e. in a Representation element). The @value of the RWPK descriptor with @schemeldUri equal to “urn:mpeg:dash:rwpk:2017” is as specified in Table 8B:

TABLE 8B

| @value parameter | | |
|---|---|---|
| for RWPK | | |
| descriptor | Use | Description |
| packing_type | O | Specifies the packing type of the |
| | | frame. |
| | | For ISO base media file format |
| | | Segments, packing_type shall be |
| | | equal to packing_type in |
| | | RegionWisePackingStruct as described |
| | | in ISO/IEC 23000-20 OMAF of the |
| | | Initialization Segment. When this @value |
| | | parameter is not present in a RWPK |
| | | descriptor, packing_type is inferred |
| | | to be equal to 1. |

In one example, when no RWPK descriptor is present then it indicates that the frame is not packed.

In one example, media presentation description generator 502 may be configured to generate a virtual reality information grouping (VRIG) descriptor that allows reuse of virtual reality information signaled in other descriptors (e.g. projection format and/or region on sphere covered and/or region-wise packing, and/or initial/random access viewpoint, and/or recommended viewport) for a Period, AdaptationSet, Representation, or SubRepresentation. This can result in more compact Media Presentation Descriptions (MPD). In one example, a virtual reality information grouping descriptor may be based on the following example definition:
Virtual reality information grouping (VRIG) descriptor may be present as a SupplementalProperty or EssentialProperty descriptor child element in AdaptationSet, and/or Representation, and/or SubRepresentation element.
The VRIG descriptor is a SupplementalProperty (and/or EssentialProperty) descriptor with @schemeldUri equal to “urn:mpeg:dash:vrig:2017”.

In one example, the @value of the SupplementalProperty or EssentialProperty elements using the VRIG scheme with @schemeldUri equal to “urn:mpeg:dash:vrig:2017” may be a comma separated list of values specified based on the example illustrated in Table 9:

TABLE 9

| @value parameter | | |
|---|---|---|
| for VRIG | | |
| SupplementalProperty/ | | |
| EssentialProperty | Use | Description |
| vr_info_group_id | M | Is an unsigned integer which identifies |
| | | the associated VR information. |
| | | If an AdaptationSet, or Representation, |
| | | or SubRepresentation includes a VRIG |
| | | descriptor with vr_info_group_id |
| | | @value equal to VRInfoGrpVal |
| | | following inference rules is applied: |
| | | If VRIG descriptor is a child element of |
| | | a Representation element the projection |
| | | format descriptor and/or region on sphere |
| | | covered descriptor and/or region-wise |
| | | packing descriptor, and/or initial/random |
| | | access viewpoint descriptor, and/or |
| | | recommended viewport descriptor is |
| | | inferred to be equal to the corresponding |
| | | values for the corresponding descriptor |
| | | which is a child element for a |
| | | Representation element which has the |
| | | same @value equal to VRInfoGrpVal |
| | | and which includes the corresponding |
| | | descriptor <redundant> |
| | | Option A. in the same AdaptationSet |
| | | element which is the parent of this |
| | | Representation element. |
| | | Option B. in the same MPD. |
| | | All AdaptationSet, or Representation, or |
| | | SubRepresentation with the same @value |
| | | for vr_info_group_id shall have same |
| | | @values for all of the projection |
| | | format descriptor and/or region on |
| | | sphere covered descriptor and/or region- |
| | | wise packing descriptor, and/or initial/ |
| | | random access viewpoint descriptor, |
| | | and/or recommended viewport descriptor. |
| | | If all the Representation elements in an |
| | | AdaptationSet element have the same |
| | | value for projection format descriptor |
| | | and/or region on sphere covered descriptor |
| | | and/or region-wise packing descriptor, |
| | | and/or initial/random access viewpoint |
| | | descriptor, and/or recommended viewport |
| | | descriptor then each of those descriptors |
| | | may/should be used at the AdaptationSet |
| | | element which is the parent of those |
| | | Representation elements. |
| | | vr_info_group_id @value shall share the |
| | | same value space regardless of if VRIG |
| | | descriptor is a child element of |
| | | AdaptationSet, or Representation, or |
| | | SubRepresentation element. |

In one example, each of the following descriptors will include afield (e.g., in comma separated values list in the coresponding @value of the SupplementalProperty/EssentialProperty descriptor) which includes an identifier for that information in that descriptor. This ID field will be the last optional filed in each of these descriptors. In one example, this ID field will be the first mandatory field in each of those descriptors. This @value may be based on the example illustrated in Table 10:

TABLE 10

| | @value parameter | | |
|---|---|---|---|
| | for in the list of | | |
| | CSV parameters | | |
| | SupplementalProperty/ | | |
| Descriptor | EssentialProperty | Use | Description |
| Descriptor indicating projection | projection_format_id | O | Is an unsigned integer which identifies |
| format information including | | | the associated projection format as specified by the |
| projection type and/or | | | @schemIdURI and the comma separated @value |
| geometry type | | | list in this descriptor except for this |
| | | | projection_format_id value. A value of 0 is |
| | | | reserved and shall not be used. |
| Fisheye video information | fv_id | O | Is an unsigned integer which identifies the |
| descriptor | | | associated fisheye video information specified by |
| | | | the @schemIdURI and the comma separated |
| | | | @value list in this descriptor except for this fv_id |
| | | | value. A value of 0 is reserved and shall not be |
| | | | used. |
| Descriptor related to region- | rpacking_id | O | Is an unsigned integer which identifies the |
| wise packing | | | associated region-wise packing type as specified |
| | | | by the @schemIdURI and the comma separated |
| | | | @value list in this descriptor except for this |
| | | | projection_format_id value. A value of 0 is |
| | | | reserved and shall not be used. |
| Stereo frame packing descriptor | sfp_id | O | Is an unsigned integer which identifies the |
| | | | associated stereo frame packing information as |
| | | | specified by the @schemIdURI and the comma |
| | | | separated @value list in this descriptor except |
| | | | for this sfp_id value. A value of 0 is reserved and |
| | | | shall not be used. |

In one example, a different descriptor Virtual Reality Identifiers (VRIDS) with @schemeIdUri equal to “urn:mpeg:dash:vrids:2017” may be used. In this case the @value of the SupplementalProperty or EssentialProperty elements using the Virtual Reality Identifiers (VRIDS) scheme may be a comma separated list of values for Virtual Reality Identifiers (VRI) parameters specified based on the example illustrated in Table 11.

TABLE 11

| @value parameter | | |
|---|---|---|
| for VRIDS | | |
| SupplementalProperty/ | | |
| EssentialProperty | Use | Description |
| ref_projection_format_id | M | Is an unsigned integer which |
| | | identifies the projection format |
| | | that is inferred for the container |
| | | element (e.g. for this Representation |
| | | element). The projection format for |
| | | the container element is inferred to |
| | | be equal to the value signalled in |
| | | the SupplementalProperty or |
| | | EssentialProperty descriptor for |
| | | the Representation element or |
| | | AdaptationSet element which has the |
| | | value for its projection_format_id |
| | | in the @value equal to the value |
| | | of this ref_projection_format_id |
| | | parameter. A value of 0 for this |
| | | parameter indicates that the |
| | | projection format descriptor is |
| | | explicitly signalled in the container |
| | | element (e.g. in this Representation |
| | | element) and is not inferred. |
| ref_fv_id | M | Is an unsigned integer which |
| | | identifies the fisheye video |
| | | information descriptor that is |
| | | inferred for the container element |
| | | (e.g. for this Representation |
| | | element). The fisheye video |
| | | information for the container |
| | | element is inferred to be equal to |
| | | the value signalled in the |
| | | SupplementalProperty or |
| | | EssentialProperty descriptor for |
| | | the Representation element or |
| | | AdaptationSet element which has the |
| | | value for its fv_id in the @value |
| | | equal to the value of this ref_fv_id |
| | | parameter. A value of 0 for this |
| | | parameter indicates that the fisheye |
| | | video descriptor is explicitly |
| | | signalled in the container element |
| | | (e.g. in this Representation element) |
| | | and is not inferred. |
| ref_rpacking_id | M | Is an unsigned integer which |
| | | identifies the region-wise packing |
| | | type that is inferred for the |
| | | container element (e.g. for this |
| | | Representation element). The region- |
| | | wise packing type for the container |
| | | element is inferred to be equal to |
| | | the value signalled in the |
| | | SupplementalProperty or |
| | | EssentialProperty descriptor for the |
| | | Representation element or |
| | | AdaptationSet element which has the |
| | | value for its rpacking_id in the |
| | | @value equal to the value of |
| | | this ref_rpacking_id parameter. A |
| | | value of 0 for this parameter indicates |
| | | that the region-wise packing |
| | | descriptor is explicitly signalled in |
| | | the container element (e.g. in this |
| | | Representation element) and is not |
| | | inferred. |
| ref_sfp_id | M | Is an unsigned integer which |
| | | identifies the stereo frame packing |
| | | information that is inferred for the |
| | | container element (e.g. for this |
| | | Representation element). The stereo |
| | | frame packing information for the |
| | | container element is inferred to be |
| | | equal to the value signalled in the |
| | | SupplementalProperty or |
| | | EssentialProperty descriptor for |
| | | the Representation element or |
| | | AdaptationSet element which has |
| | | the value for its sfp_id in the @value |
| | | equal to the value of this ref_sfp_id |
| | | parameter. A value of 0 for this |
| | | parameter indicates that the initial/ |
| | | random access viewpoint descriptor |
| | | is explicitly signalled in the |
| | | container element (e.g. in this |
| | | Representation element) and is |
| | | not inferred. |

In one example, the following constraint may be required: At least one of ref_projection_format_idreffv_id is equal to 0. This may be because the video content (e.g. a Representation/SubRepresentation) is either projected frame content or fisheye video content, but not both.

In one example, for each of ref_projection_format_id, ref_fv_id, ref_rpacking_id, ref_sfp_id parameters a value of 0 indicates that the recommended viewport descriptor is explicitly signalled in the container element (e.g. in this Representation element) or is not signalled (thus is unspecified) and is not inferred.

In one example, for each of ref_projection_format_id ref_fv_id, ref_rpacking_id, ref_sfp_id parameters a value of 0 indicates that the recommended viewport descriptor is explicitly signalled in the container element (e.g. in this Representation element) and is not inferred and for each of ref_projection_format_id, ref_fv_id, ref_rpacking_id, ref_sfp_id parameters a value of 1 indicates that the recommended viewport descriptor is =not signalled and is not inferred and thus is unspecified for this container element (e.g. in this Representation element). In this case for each of ref_projection_format_id, ref_fv_id, ref_rpacking_id, ref_sfp_id parameters the value of 0 and 1 is reserved and shall not be used.

In one example some or all of the descriptor defined above may be used inside a content component (ContentComponent element).

Further, in one example media presentation description generator 502 may be configured to generate a SupplementalProperty coverage map (CM) descriptor element based on the following example definition:
A SupplementalProperty coverage map (CM) descriptor element with a @schemeldUri attribute equal to “urn:mpeg:dash:rwqr:2017” may be present at adaptation set level (i.e. in a AdaptationSet element). The @value of the CM descriptor with @schemeldUri equal to “urn:mpeg:dash:rwqr:2017” is a comma separated list of values as specified in Table 12:

TABLE 12

| @value parameter | | |
|---|---|---|
| for CM | | |
| descriptor | Use | Description |
| center_yaw | M | Specifies the yaw of the center point |
| | | the region in degrees relative to the |
| | | global coordinate system. For ISO base |
| | | media file format Segments, center_yaw |
| | | shall be equal to center_yaw in |
| | | RegionOnSphereStruct as described in |
| | | ISO/IEC 23000-20 OMAF of the |
| | | Initialization Segment |
| center_pitch | M | Specifies the pitch of the center point |
| | | the region in degrees relative to the |
| | | global coordinate system. For ISO base |
| | | media file format Segments, center_pitch |
| | | shall be equal to center_pitch in |
| | | RegionOnSphereStruct as described in |
| | | ISO/IEC 23000-20 OMAF of the |
| | | Initialization Segment |
| hor_range | M | Specifies the horizontal range of the |
| | | region through the center point of |
| | | the region. For ISO base media file |
| | | format Segments, hor_range shall be |
| | | equal to hor_range in |
| | | RegionOnSphereStruct as described in |
| | | ISO/IEC 23000-20 OMAF of the |
| | | Initialization Segment. |
| ver_range | M | Specifies the vertical range of the |
| | | region through the center point of |
| | | the region. For ISO base media file |
| | | format Segments, ver_range shall be |
| | | equal to ver_range in |
| | | RegionOnSphereStruct as described in |
| | | ISO/IEC 23000-20 OMAF of the |
| | | Initialization Segment. |

In one example for center_yaw, center_pitch, hor_range, ver_range above the RegionOnSphereStruct may be included inside a another box (for example a regionwise quality box). In this manner, media presentation description generator 502 represents an example of a device configured to signal information associated with a virtual reality application according to one or more of the techniques described herein.

Referring again to FIG. 1, interface 108 may include any device configured to receive data generated by data encapsulator 107 and transmit and/or store the data to a communications medium. Interface 108 may include a network interface card, such as an Ethernet card, and may include an optical transceiver, a radio frequency transceiver, or any other type of device that can send and/or receive information. Further, interface 108 may include a computer system interface that may enable a file to be stored on a storage device. For example, interface 108 may include a chipset supporting Peripheral Component Interconnect (PCI) and Peripheral Component Interconnect Express (PCIe) bus protocols, proprietary bus protocols, Universal Serial Bus (USB) protocols, PC, or any other logical and physical structure that may be used to interconnect peer devices.

Referring again to FIG. 1, destination device 120 includes interface 122, data decapsulator 123, video decoder 124, and display 126. Interface 122 may include any device configured to receive data from a communications medium. Interface 122 may include a network interface card, such as an Ethernet card, and may include an optical transceiver, a radio frequency transceiver, or any other type of device that can receive and/or send information. Further, interface 122 may include a computer system interface enabling a compliant video bitstream to be retrieved from a storage device. For example, interface 122 may include a chipset supporting PCI and PCIe bus protocols, proprietary bus protocols, USB protocols, PC, or any other logical and physical structure that may be used to interconnect peer devices. Data decapsulator 123 may be configured to receive a bitstream generated by data encaspulator 107 and perform sub-bitstream extraction according to one or more of the techniques described herein.

Video decoder 124 may include any device configured to receive a bitstream and/or acceptable variations thereof and reproduce video data therefrom. Display 126 may include any device configured to display video data. Display 126 may comprise one of a variety of display devices such as a liquid crystal display (LCD), a plasma display, an organic light emitting diode (OLED) display, or another type of display. Display 126 may include a High Definition display or an Ultra High Definition display. Display 126 may include a stereoscopic display. It should be noted that although in the example illustrated in FIG. 1, video decoder 124 is described as outputting data to display 126, video decoder 124 may be configured to output video data to various types of devices and/or sub-components thereof. For example, video decoder 124 may be configured to output video data to any communication medium, as described herein. Destination device 120 may include a receive device.

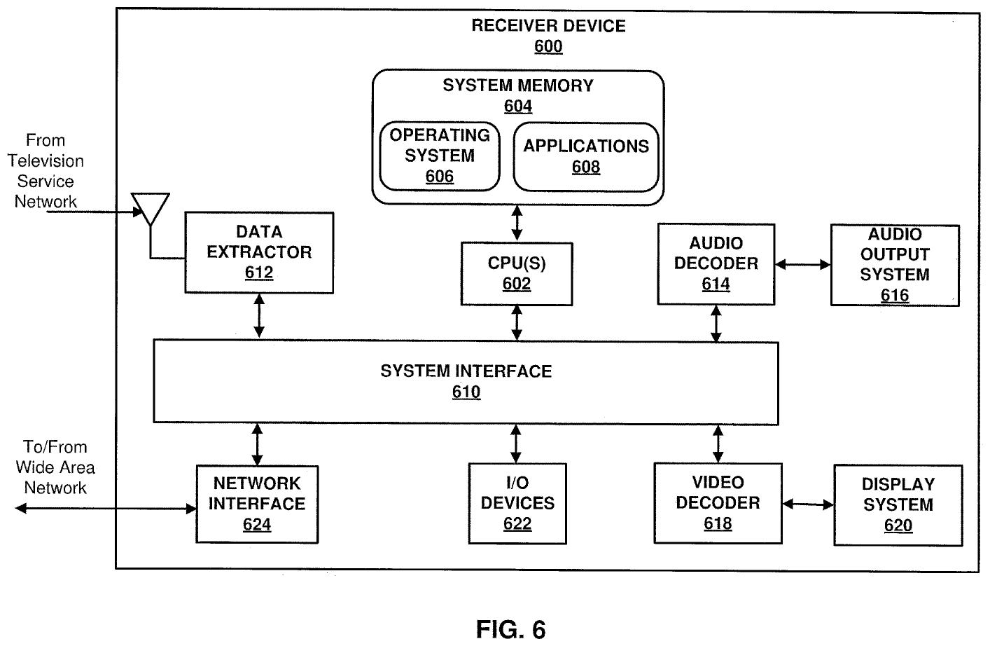

FIG. 6 is a block diagram illustrating an example of a receiver device that may implement one or more techniques of this disclosure. That is, receiver device 600 may be configured to parse a signal based on the semantics described above with respect to one or more of the tables described above. Receiver device 600 is an example of a computing device that may be configured to receive data from a communications network and allow a user to access multimedia content, including a virtual reality application. In the example illustrated in FIG. 6, receiver device 600 is configured to receive data via a television network, such as, for example, television service network 404 described above. Further, in the example illustrated in FIG. 6, receiver device 600 is configured to send and receive data via a wide area network. It should be noted that in other examples, receiver device 600 may be configured to simply receive data through a television service network 404. The techniques described herein may be utilized by devices configured to communicate using any and all combinations of communications networks.

As illustrated in FIG. 6, receiver device 600 includes central processing unit(s) 602, system memory 604, system interface 610, data extractor 612, audio decoder 614, audio output system 616, video decoder 618, display system 620, I/O device(s) 622, and network interface 624. As illustrated in FIG. 6, system memory 604 includes operating system 606 and applications 608. Each of central processing unit(s) 602, system memory 604, system interface 610, data extractor 612, audio decoder 614, audio output system 616, video decoder 618, display system 620, I/O device(s) 622, and network interface 624 may be interconnected (physically, communicatively, and/or operatively) for inter-component communications and may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof. It should be noted that although receiver device 600 is illustrated as having distinct functional blocks, such an illustration is for descriptive purposes and does not limit receiver device 600 to a particular hardware architecture. Functions of receiver device 600 may be realized using any combination of hardware, firmware and/or software implementations.

CPU(s) 602 may be configured to implement functionality and/or process instructions for execution in receiver device 600. CPU(s) 602 may include single and/or multi-core central processing units. CPU(s) 602 may be capable of retrieving and processing instructions, code, and/or data structures for implementing one or more of the techniques described herein. Instructions may be stored on a computer readable medium, such as system memory 604.

System memory 604 may be described as a non-transitory or tangible computer-readable storage medium. In some examples, system memory 604 may provide temporary and/or long-term storage. In some examples, system memory 604 or portions thereof may be described as non-volatile memory and in other examples portions of system memory 604 may be described as volatile memory. System memory 604 may be configured to store information that may be used by receiver device 600 during operation. System memory 604 may be used to store program instructions for execution by CPU(s) 602 and may be used by programs running on receiver device 600 to temporarily store information during program execution. Further, in the example where receiver device 600 is included as part of a digital video recorder, system memory 604 may be configured to store numerous video files.

Applications 608 may include applications implemented within or executed by receiver device 600 and may be implemented or contained within, operable by, executed by, and/or be operatively/communicatively coupled to components of receiver device 600. Applications 608 may include instructions that may cause CPU(s) 602 of receiver device 600 to perform particular functions. Applications 608 may include algorithms which are expressed in computer programming statements, such as, for-loops, while-loops, if-statements, do-loops, etc. Applications 608 may be developed using a specified programming language. Examples of programming languages include, Java™, Jini™, C, C++, Objective C, Swift, Perl, Python, PhP, UNIX Shell, Visual Basic, and Visual Basic Script. In the example where receiver device 600 includes a smart television, applications may be developed by a television manufacturer or a broadcaster. As illustrated in FIG. 6, applications 608 may execute in conjunction with operating system 606. That is, operating system 606 may be configured to facilitate the interaction of applications 608 with CPUs(s) 602, and other hardware components of receiver device 600. Operating system 606 may be an operating system designed to be installed on set-top boxes, digital video recorders, televisions, and the like. It should be noted that techniques described herein may be utilized by devices configured to operate using any and all combinations of software architectures.

System interface 610 may be configured to enable communications between components of receiver device 600. In one example, system interface 610 comprises structures that enable data to be transferred from one peer device to another peer device or to a storage medium. For example, system interface 610 may include a chipset supporting Accelerated Graphics Port (AGP) based protocols, Peripheral Component Interconnect (PCI) bus based protocols, such as, for example, the PCI Express™ (PCIe) bus specification, which is maintained by the Peripheral Component Interconnect Special Interest Group, or any other form of structure that may be used to interconnect peer devices (e.g., proprietary bus protocols).

As described above, receiver device 600 is configured to receive and, optionally, send data via a television service network. As described above, a television service network may operate according to a telecommunications standard. A telecommunications standard may define communication properties (e.g., protocol layers), such as, for example, physical signaling, addressing, channel access control, packet properties, and data processing. In the example illustrated in FIG. 6, data extractor 612 may be configured to extract video, audio, and data from a signal. A signal may be defined according to, for example, aspects DVB standards, ATSC standards, ISDB standards, DTMB standards, DMB standards, and DOCSIS standards.

Data extractor 612 may be configured to extract video, audio, and data, from a signal. That is, data extractor 612 may operate in a reciprocal manner to a service distribution engine. Further, data extractor 612 may be configured to parse link layer packets based on any combination of one or more of the structures described above.

Data packets may be processed by CPU(s) 602, audio decoder 614, and video decoder 618. Audio decoder 614 may be configured to receive and process audio packets. For example, audio decoder 614 may include a combination of hardware and software configured to implement aspects of an audio codec. That is, audio decoder 614 may be configured to receive audio packets and provide audio data to audio output system 616 for rendering. Audio data may be coded using multi-channel formats such as those developed by Dolby and Digital Theater Systems. Audio data may be coded using an audio compression format. Examples of audio compression formats include Motion Picture Experts Group (MPEG) formats, Advanced Audio Coding (AAC) formats, DTS-HD formats, and Dolby Digital (AC-3) formats. Audio output system 616 may be configured to render audio data. For example, audio output system 616 may include an audio processor, a digital-to-analog converter, an amplifier, and a speaker system. A speaker system may include any of a variety of speaker systems, such as headphones, an integrated stereo speaker system, a multi-speaker system, or a surround sound system.

Video decoder 618 may be configured to receive and process video packets. For example, video decoder 618 may include a combination of hardware and software used to implement aspects of a video codec. In one example, video decoder 618 may be configured to decode video data encoded according to any number of video compression standards, such as ITU-T H.262 or ISO/JEC MPEG-2 Visual, ISO/JEC MPEG-4 Visual, ITU-T H.264 (also known as ISO/JEC MPEG-4 Advanced video Coding (AVC)), and High-Efficiency Video Coding (HEVC). Display system 620 may be configured to retrieve and process video data for display. For example, display system 620 may receive pixel data from video decoder 618 and output data for visual presentation. Further, display system 620 may be configured to output graphics in conjunction with video data, e.g., graphical user interfaces. Display system 620 may comprise one of a variety of display devices such as a liquid crystal display (LCD), a plasma display, an organic light emitting diode (OLED) display, or another type of display device capable of presenting video data to a user. A display device may be configured to display standard definition content, high definition content, or ultra-high definition content.

I/O device(s) 622 may be configured to receive input and provide output during operation of receiver device 600. That is, I/O device(s) 622 may enable a user to select multimedia content to be rendered. Input may be generated from an input device, such as, for example, a push-button remote control, a device including a touch-sensitive screen, a motion-based input device, an audio-based input device, or any other type of device configured to receive user input. I/O device(s) 622 may be operatively coupled to receiver device 600 using a standardized communication protocol, such as for example, Universal Serial Bus protocol (USB), Bluetooth, ZigBee or a proprietary communications protocol, such as, for example, a proprietary infrared communications protocol.

Network interface 624 may be configured to enable receiver device 600 to send and receive data via a local area network and/or a wide area network. Network interface 624 may include a network interface card, such as an Ethernet card, an optical transceiver, a radio frequency transceiver, or any other type of device configured to send and receive information. Network interface 624 may be configured to perform physical signaling, addressing, and channel access control according to the physical and Media Access Control (MAC) layers utilized in a network. Receiver device 600 may be configured to parse a signal generated according to any of the techniques described above with respect to FIG. 5. In this manner, receiver device 600 represents an example of a device configured parse one or more syntax elements including information associated with a virtual reality application.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

Various examples have been described. These and other examples are within the scope of the following claims.

1. A method of generating a packed picture, the method comprising:
receiving a projection format descriptor including projection type information; and
generating the packed picture by using a projected picture,
wherein
the projection type information specifies a list of projection type values of the projected picture.

2. The method of claim 1, wherein projection formats of the list of projection type values are identified by an unsigned integer value, wherein the projection formats include an equirectangular projection format.

3. The method of claim 1, wherein the projection format descriptor in a representation element applies when both an adaptation set element and the representation element have the projection format descriptor.

4. The method of claim 1, further comprising:
receiving a region-wise packing descriptor including a region-wise packing type, wherein the region-wise packing type specifies a list of packing type values of a picture.

5. The method of claim 1, wherein region-wise packing formats of the region-wise packing type are identified by a 4-bit unsigned integer value, wherein the region-wise packing formats include a rectangular region-wise packing format.

6. (canceled)

7. A device comprising one or more processors configured to perform any and all combinations of the steps of claim 1.

8. (canceled)

9. (canceled)

10. (canceled)

11. A non-transitory computer-readable storage medium comprising instructions stored thereon that, when executed, cause one or more processors of a device to perform any and all combinations of the steps of claim 1.
